(19) United States
(12) Patent Application Publication
(10) Pub. No.: US 2026/0079503 A1
(43) Pub. Date: Mar. 19, 2026

(54) INFORMATION PROCESSING APPARATUS, INFORMATION PROCESSING METHOD, INFORMATION PROCESSING SYSTEM, AND NON-TRANSITORY COMPUTER READABLE MEDIUM

(71) Applicant: KABUSHIKI KAISHA TOSHIBA, Kawasaki-shi (JP)

(72) Inventors: Shizu SAKAKIBARA, Kawasaki (JP); Hideyuki AISU, Kawasaki (JP); Kanau KUMEKAWA, Kawasaki (JP); Michio YAMASHITA, Itabashi (JP); Takufumi YOSHIDA, Funabashi (JP)

(73) Assignee: KABUSHIKI KAISHA TOSHIBA, Kawasaki-shi (JP)

(21) Appl. No.: 19/302,693

(22) Filed: Aug. 18, 2025

(30) Foreign Application Priority Data
Sep. 17, 2024 (JP) 2024-160174

(51) Int. Cl. G05D 1/693; G05D 1/698

(52) U.S. Cl. CPC G05D 1/693; G05D 1/6987

(57) ABSTRACT

The present embodiments relate to an information processing apparatus for generating a route for a moving object. The apparatus includes a processing circuitry configured to generate a route for a first moving object including one or more of a plurality of movement paths, each of which allows movement in a first direction and a second direction opposite to the first direction, based on a first weight in the first direction and a second weight in the second direction associated with each movement path; update at least one of the first weight and the second weight for a movement path included in the route for the first moving object based on a movement direction of the first moving object; and generate a route for a second moving object based on the updated at least one of the first weight and the second weight.

### CROSS REFERENCE TO RELATED APPLICATIONS

This application is based upon and claims the benefit of priority from the prior Japanese Patent Application No. 2024-160174, filed on Sep. 17, 2024, the entire contents of which are incorporated herein by reference.

### FIELD

Embodiments described herein relate to an information processing apparatus, an information processing method, an information processing system and a non-transitory computer readable medium.

### BACKGROUND

In recent years, with the popularization of high-mix low-volume production, it has become necessary to create flexibility in the production process. For example, the processes of a production line are modularized and freely rearranged and deliveries between the processes are made using AGVs (Automatic Guided Vehicles), or mobile robots with a working arm are caused to work while moving across a plurality of work locations.

Further, against the backdrop of a serious labor shortage at logistics sites, efforts to save labor are accelerating at logistics centers such as for online shopping. For example, there is a method for responding to this by combining AGVs or self-driving forklifts with picking robots.

Furthermore, with the advancement of self-driving technology for automobiles, automatic valet parking, in which automobiles are caused to automatically move and park in a parking lot in an unmanned state, or attempts such as moving unmanned construction machine moving objects remotely controlled at construction sites or mining sites have also reached a practical level. In order to efficiently control the movement of a large number of self-driving moving objects in a small area, it is necessary to appropriately determine the routes for the moving objects.

In order to avoid contention between the moving objects such as collisions and deadlocks, it has been common to provide in advance a plurality of dedicated movement paths, such as double-track movement paths that make it possible to simultaneously move in both directions and one-way loops, as well as moving spaces.

However, even in the case of using movement paths having a shape that inevitably causes movement in both directions, or using in advance a route that causes movement in both directions for reasons such as safety or the like, it is required to be able to avoid contention and create an operation plan in a versatile manner. At this time, it is also desired to adjust the traffic between movement paths, such as to prevent movements of moving objects from concentrating (congesting) on a particular passage.

### BRIEF DESCRIPTION OF THE DRAWINGS

FIG. 1 is a diagram showing an example of a configuration of a route generation system 10 that is an information processing system according to a first embodiment;

FIG. 2 is a schematic diagram planarly showing a movement environment including a plurality of movement paths;

FIG. 3 is a diagram showing an example of a movement path network in which the movement environment in FIG. 2 is represented in a graph format;

FIG. 4 is a diagram showing an example in which information indicating the departure points and the arrival points of AGVs 1-3 is shown in association with the movement path network;

FIG. 5 is a diagram showing an example of congestion adjustment parameters stored in a congestion adjustment parameter storage;

FIG. 6 is a diagram showing links for which the congestion adjustment parameters in the forward and reverse directions shown in FIG. 5 are set in the movement path network;

FIG. 7 is a flowchart showing an example of processing in a route planner;

FIG. 8 is a diagram showing an example of setting initial weights for a link in a first direction and a second direction;

FIG. 9 is a diagram showing the first direction of each of links 1-19;

FIG. 10 is a diagram showing an example of a weight table in the first direction and a weight table in the second direction;

FIG. 11 is a diagram showing an example of a route generated for the AGV 1;

FIG. 12 is a diagram showing an example of a route generated for the AGV 2;

FIG. 13 is a diagram showing an example of a route generated for the AGV 3;

FIG. 14 is a diagram showing an example of a route generated for the AGV 1;

FIG. 15 is a diagram showing an example of a weight table in the first direction and a weight table in the second direction;

FIG. 16 is a diagram showing an example of a route generated for the AGV 2;

FIG. 17 is a diagram showing an example of a route generated for the AGV 3;

FIG. 18 is a diagram showing an example of a route generated for the AGV 1;

FIG. 19 is a diagram showing an example of a weight table in the first direction and a weight table in the second direction;

FIG. 20 is a diagram showing an example of a route generated for the AGV 2;

FIG. 21 is a diagram showing an example of a route generated for the AGV 3;

FIG. 22 is a diagram showing an example in which some links are fixed in advance as planned for the AGV 2;

FIG. 23 is a diagram showing an example of a weight table in the first direction and a weight table in the second direction;

FIG. 24 is a diagram showing an example of a route generated for the AGV 1;

FIG. 25 is a diagram showing an example of a route generated for the AGV 2;

FIG. 26 is a diagram showing an example of a route generated for the AGV 3;

FIG. 27 is a diagram showing a data example in a congestion adjustment parameter storage according to this embodiment;

FIG. 28 is a diagram showing links for which the congestion adjustment parameter in both directions and the congestion adjustment parameter in the reverse direction are set;

FIG. 29 is a diagram showing an example of a route generated for the AGV 1;

FIG. 30 is a diagram showing an example of a weight table in the first direction and a weight table in the second direction;

FIG. 31 is a diagram showing an example of a route generated for the AGV 2;

FIG. 32 is a diagram showing an example of a route generated for the AGV 3;

FIG. 33 is a diagram showing an example of congestion adjustment parameters according to this embodiment;

FIG. 34 is a diagram showing an example of a weight table in the first direction and a weight table in the second direction;

FIG. 35 is a diagram showing an example of a route generated for the AGV 1;

FIG. 36 is a diagram showing an example of a route generated for the AGV 2;

FIG. 37 is a diagram showing an example of a route generated for the AGV 3; and

FIG. 38 is a diagram showing a hardware configuration of an information processing apparatus according to an embodiment of the present invention.

### DETAILED DESCRIPTION

According to one embodiment, an information processing apparatus includes a processing circuitry configured to: generate a route for a first moving object including one or more of a plurality of movement paths, each of which allows movement in a first direction and a second direction opposite to the first direction, based on a first weight in the first direction and a second weight in the second direction associated with each movement path; update at least one of the first weight and the second weight for the movement path included in the route for the first moving object, based on a movement direction of the first moving object on the movement path; and generate a route for a second moving object including one or more of the movement paths, based on the updated at least one of the first weight and the second weight.

Hereinafter, embodiments of the present invention will be described with reference to the drawings.

### First Embodiment

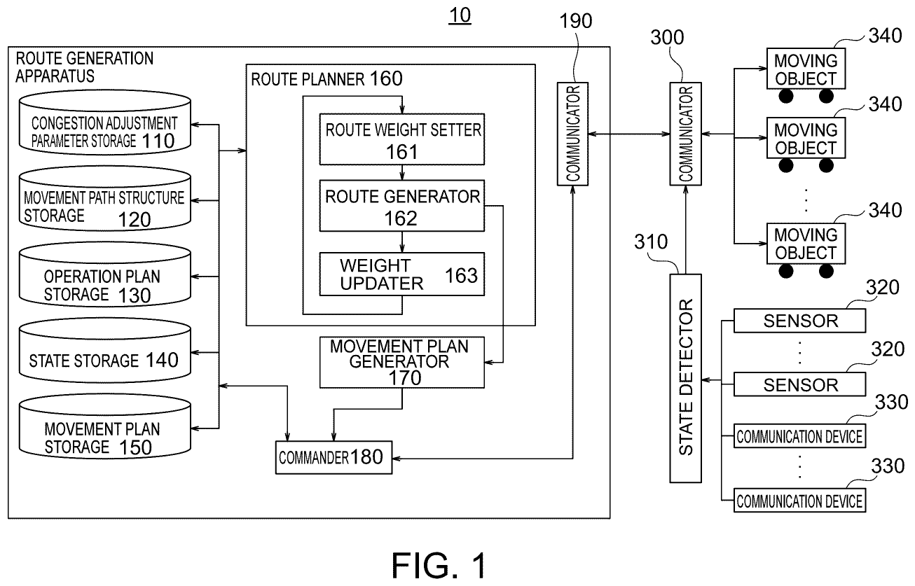

FIG. 1 shows an example of a configuration of a route generation system 10 that is an information processing system according to a first embodiment. The route generation system 10 includes a route generation apparatus 100 that is an information processing apparatus according to the first embodiment, a communicator 300, a state detector 310, a plurality of sensors 320, a plurality of communication devices 330, and a plurality of moving objects (a first moving object, a second moving object, . . . , an M-th moving object) 340. The moving object may be a moving vehicle.

A moving object according to this embodiment is an automatically movable (e.g., travelable) moving object, such as an AGV (Automatic Guided Vehicle), an autonomous mobile robot, a self-driving vehicle (e.g., a self-driving car), and a flying body. For example, the moving objects move on movement paths arranged in an area such as in 20 a factory, a warehouse, or a facility premise (hereinafter referred to as a movement path). As an example, the moving objects are equipped with a storage battery (a battery) and operate using power stored in the battery. The environment in which the moving objects move is referred to as a movement environment. The following description assumes a case where the moving objects are AGVs.

The communicator 300 is disposed in a facility where the moving objects 340 move or at any other points. The communicator 300 relays communications between the moving objects 340 and the route generation apparatus 100. The communicator 300 can communicate with a communicator 190 of the route generation apparatus 100. Further, the communicator 300 can communicate with the moving objects 340 and the state detector 310. These communications may be either wired or wireless. The communicator 300 receives a control command for a moving object 340 from the route generation apparatus 100 and transmits it to the moving object 340. This causes the moving object 340 to operate according to a movement plan generated by the route generation apparatus 100.

The sensors 320 are disposed in the facility where the moving objects 340 move or at any other points, and detect the states of moving objects 340 passing through the sensing range. For example, the position, speed and the like of a moving object 340 may be detected, or the operation of a moving object 340 (e.g., whether or not it has a load, whether or not it is in an immovable state due to falling over, etc.) may be detected.

The communication devices 330 are disposed in the facility where the moving objects 340 move or at any other points, and communicate with the moving objects 340 in a communication method different from that of the communicator 300. For example, the communicator 300 may be based on a wireless LAN, and the communication device 330 may be based on Bluetooth Low Energy (BLE). By using the communication devices 330, information on the state of a moving object 340 can be acquired even when the moving object 340 is located in an area where it cannot communicate with the communicator 300. The communication devices 330 may acquire, for example, the same type of information as the information detected by the sensors 320 from the moving objects 340. Thereby, even when a moving object 340 does not pass through the sensing ranges of the sensors 320, information on the state of the moving object 340 can be acquired.

The state detector 310 acquires information on the states of the moving objects 340 from the sensors 320 and the communication devices 330, and transmits the acquired information to the communicator 300. The communicator 300 acquires the information on the states of the moving objects 340 from the state detector 310, and transmits the acquired information to the route generation apparatus 100.

The route generation apparatus 100 includes storages 110-150, a route planner 160, a movement plan generator 170, a commander 180, and the communicator 190. At least one of the route planner 160, the movement plan generator 170, and the commander 180 corresponds to a processing circuitry that performs processing according to this embodiment. The commander 180 corresponds to a controller or a controlling circuitry that controls the moving objects 340.

An inputter for inputting information to the storages 110-150 may be provided. The inputter may acquire information input by a user using a keyboard, a mouse, a touch panel, voice input means, or the like, and store the information in the storages 110-150. An outputter for outputting information stored in the storages 110-150 may be provided. The outputter may be, for example, a display device or a communicator that communicates with a user terminal.

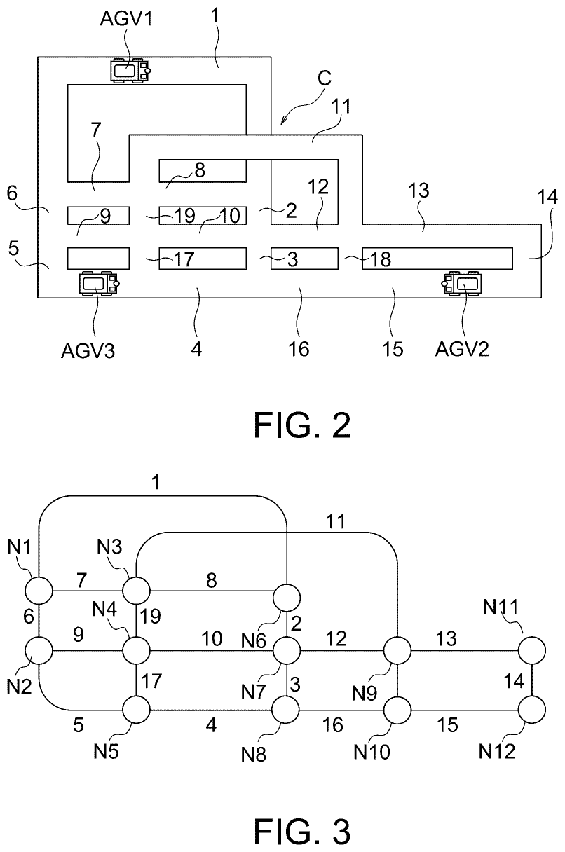

FIG. 2 is a schematic diagram planarly showing a movement environment including a plurality of movement paths. In the movement environment shown in FIG. 2, a plurality of movement paths 1-19 are shown. The movement paths 1-19 are connected to each other. Further, a plurality of AGVs 1-3 are arranged as a plurality of moving objects. A point where movement paths are connected corresponds to an intersection. The movement path 1 and the movement path 11 cross at different heights, and the crossing point C is not an intersection. A state is shown in which the AGV 1 moves on the movement path 1 in the right direction of FIG. 2, the AGV 2 moves on the movement path 15 in the left direction of FIG. 2, and the AGV 3 moves on the movement path 5 in the right direction of FIG. 2. The individual movement paths may be of any shape, such as a straight line, a curve, or a shape in which a straight line and a curve are combined. The travelling method of an AGV may be any method, such as a method of traveling on a guide tape placed on the floor, a method of placing markers at key parts and moving between the markers, or a method in which an AGV itself detects its own position, generates virtual movement paths, and moves thereon. In each movement path, when the direction of movement from one end to the other end of the movement path is referred to as a first direction and the direction of movement from the other end to the one end is referred to as a second direction, a moving object can move in the first direction and the second direction that is the opposite direction of the first direction.

The movement path structure storage 120 stores a movement path network in which the movement environment is represented in a graph format.

FIG. 3 is an example of a movement path network in which the movement environment in FIG. 2 is represented in a graph format. This movement path network includes a plurality of nodes N1-N12 and a plurality of links 1-19 connecting the nodes. Hereinafter, a method of generating the movement path network in FIG. 3 will be described.

In the method of generating the movement path network, nodes are first generated for a plurality of points in the movement environment, such as the intersection parts (intersections) of a plurality of movement paths, and any positions on the movement paths. A node may be generated for the departure point or the arrival point of an AGV. Then, when an AGV can move between two points, a link (also referred to as an arc) is generated between the two nodes corresponding to the two points. A link corresponds to a movement path in the movement environment. A movement path and a link corresponding to each other are identified with the same reference numeral. For example, the link corresponding to the movement path 2 is represented as the link 2. In this way, a movement path network including nodes and links connecting the nodes can be generated. Since the movement path network is a graph, the length and orientation of a movement path do not necessarily correspond to the length and orientation of the link at the corresponding point in the movement path network.

In the following description, an AGV moving on a movement path is also represented as the AGV moving on a link. Further, an AGV passing through or departing from the position of a node (an intersection or any positions) is also represented as the AGV passing through or departing from the node. An AGV stopping at the position of a node is also represented as the AGV stopping at the node.

The operation plan storage 130 stores an operation plan including the departure point and the arrival point for each moving object (AGV). For each AGV, the departure point and the arrival point may be different. Further, the operation plan storage 130 may store the departure time of an AGV. Further, when a via point via which an AGV moves to the arrival point is determined in advance, the information on the via point may be stored. Further, when an AGV has a task to perform on the way to the arrival point (e.g., raising or lowering a load), the operation plan storage 130 may store the content of the task and information on the point where the task is performed.

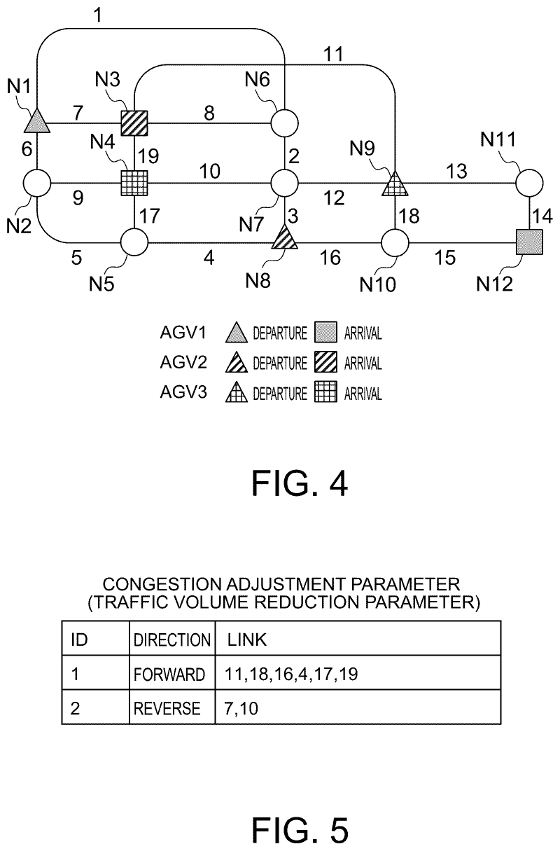

FIG. 4 shows an example in which information indicating the departure points (also referred to as departure nodes) and the arrival points (also referred to as arrival nodes) of the AGVs 1-3 is shown in association with the movement path network. The departure point and the arrival point of each of the AGVs 1-3 are nodes in the movement path network shown in FIG. 3. In the example in FIG. 4, a departure point is represented by a triangle and an arrival point is represented by a square. The departure point and the arrival point of the AGV 1 are the node N1 and the node N12, the departure point and the arrival point of the AGV 2 are the node N8 and the node N3, and the departure point and the arrival point of the AGV 3 are the node N9 and the node N4.

The state storage 140 stores the state of each moving object (AGV). The state of an AGV includes the initial state of the AGV (the state before departure) and the state at each time point from departure to arrival (e.g., the real-time state). The state of an AGV includes various elements such as the position, the presence/absence of a load, the speed, the movement directions on movement paths, and the remaining battery level of the AGV. Further, the state storage 140 may store specification information about an AGV, such as the standard speed, the maximum speed, the minimum speed, the size, and moveable directions of the AGV. The state of an AGV may be acquired by the communicator 190 communicating with the AGV 340 via the communicator 300, or may be acquired from the state detector 310 that detects the AGV via at least one of the sensors 320 and the communication devices 330. When an AGV is located outside the communication range of the communicator 300, the state detector 310 can detect the AGV via the sensor 320 or the communication device 330 disposed in a movement path, an intersection part or the like.

The movement plan storage 150 stores a movement plan for each AGV generated by the route planner 160 described later. As an example, a movement plan is a plan that defines a route (a set of movement paths) along which each AGV moves and the timing (time) when it passes through each point in the route, and the timing is adjusted to avoid contention (e.g., collision) between AGVs. A movement plan may include information about points through which an AGV passes, such as the departure point, the arrival point and via points, and timing when it passes through each point (e.g., at least one of the arrival time, the departure time, and the transit time for each point). Alternatively, a movement plan may include a list in which points (or links) through which each AGV passes are arranged in order of passage and include, for a point through which a plurality of AGVs pass in common, order information that determines the order of passage. In the actual operation of AGVs, it is necessary to control the movement of each AGV so as to keep to this order. This avoids contention (e.g., collision) between AGVs.

The congestion adjustment parameter storage 110 stores a direction in which the traffic volume (congestion) is desired to be alleviated among the forward direction, the reverse direction, or both directions and link identifiers (link IDs) in association with each other. The forward direction is the direction in which a moving object moves, the reverse direction is the opposite direction of the direction in which the moving object moves, and both directions are both the forward and reverse directions. In this way, the information associating link identifiers with a direction in which congestion is desired to be alleviated is referred to as a congestion adjustment parameter. In particular, since the purpose is to alleviate congestion, it is also referred to as a traffic volume reduction parameter. The congestion adjustment parameters may be set by the user entering information using an input device.

When there is a link (a movement path) for which congestion is desired to be alleviated, a congestion adjustment parameter is set for the link. For example, a congestion adjustment parameter may be set to a link including a location where congestion is known to occur on a daily basis. It may be set to a link for which it is desired to temporarily or daily alleviate congestion of AGVs. Examples of such links include links corresponding to movement paths with fire shutters, links corresponding to movement paths where it is not desired for AGVs to stay as much as possible, and links corresponding to movement paths through which people pass.

The congestion adjustment parameter in the forward direction is set for a link when it is desired to reduce the number of AGVs simultaneously traveling on the link in the same direction. That is, the congestion adjustment parameter in the forward direction is set when it is desired to alleviate congestion in a case where there are a plurality of AGVs simultaneously moving in the same direction (congestion in the forward direction). For example, when a plurality of AGVs are lining up in the same direction, the distances between vehicles become shorter and congestion may occur.

The congestion adjustment parameter in the reverse direction is set for a link when it is desired to reduce the number of AGVs simultaneously traveling on the link in the reverse direction to the traveling direction of an AGV. In other words, the congestion adjustment parameter in the reverse direction is set when it is desired to alleviate congestion due to AGVs passing each other in the opposite directions (congestion in the reverse direction). For example, some AGVs may take longer to avoid AGVs coming from the opposite side, which may result in congestion on the link.

The congestion adjustment parameter in both directions is set for a link when both the congestion in the reverse direction and the congestion in the forward direction described above are desired to be reduced for the link.

In this way, a congestion adjustment parameter can be set for each link according to the direction of congestion desired to be prevented from occurring. As an internal process, for example, setting a congestion adjustment parameter for a link may correspond to setting the value of the congestion adjustment parameter to “1”, and not setting a congestion adjustment parameter may correspond to setting the value of the congestion adjustment parameter to “0”.

FIG. 5 shows an example of congestion adjustment parameters stored in the congestion adjustment parameter storage 110. The congestion adjustment parameter in the forward direction is set for the links 11, 18, 16, 4, 17 and 19. The congestion adjustment parameter in the reverse direction is set for the links 7 and 10. In this example, there is no link for which the congestion adjustment parameter in both directions is set. The IDs in the figure are IDs each of which identifies a respective one of the forward direction and the reverse direction. A link for which a congestion adjustment parameter is set is also referred to as a specified link. Further, a movement path corresponding to a link for which a congestion adjustment parameter is set is also referred to as a target movement path that is targeted for reducing or increasing traffic volume.

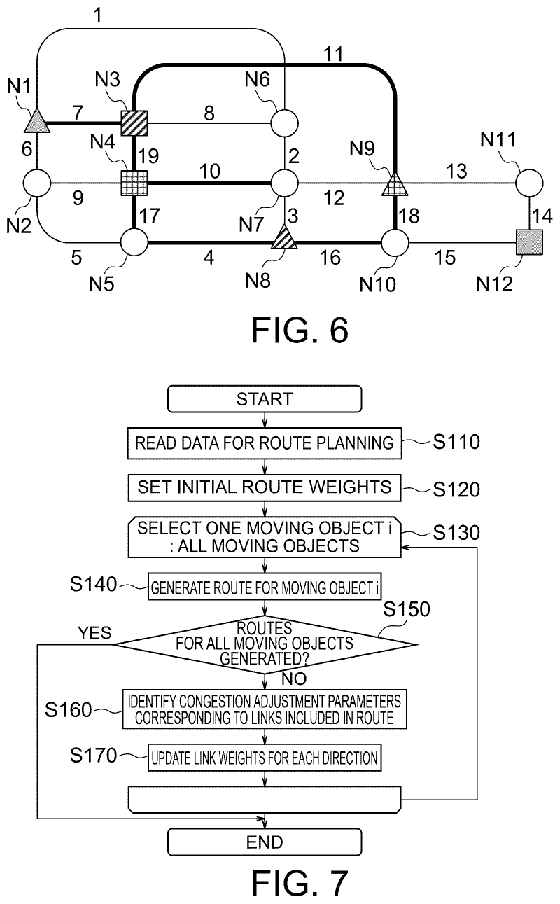

FIG. 6 shows links in which the congestion adjustment parameters in the forward and reverse directions shown in FIG. 5 are set in the movement path network. The links indicated by thick solid lines correspond to the links for which the congestion adjustment parameters in the forward and reverse directions are set. In this embodiment, a route for each AGV is generated so that the congestion in the forward or reverse direction on these links is reduced.

The route planner 160 includes a route weight setter 161, a route generator 162, and a weight updater 163. Hereinafter, the processing in the route planner 160 will be described with reference to FIG. 7.

FIG. 7 is a flowchart showing an example of processing in the route planner 160 as an information processing method according to this embodiment.

The route planner 160 reads out data from the congestion adjustment parameter storage 110, the movement path structure storage 120, the operation plan storage 130, and the state storage 140 as data for route planning (S110). It is assumed that information on an initial state of each AGV is stored in the state storage 140.

The route weight setter 161 sets an initial weight for each link (movement path) in the movement path network for each direction (S120). The direction of movement from one end to the other end of a link is referred to as a first direction, and the direction of movement from the other end to the one end is referred to as a second direction. A weight in the first direction is referred to as a first weight, and a weight in the second direction is referred to as a second weight. As the weight in the first direction and the weight in the second direction, their respective initial weights are set as the initial weights. The initial weights can be set, for example, by calculating the cost of moving along the link using the distance, movement time, expense required for movement, and the like as variables. Alternatively, the user may set a large weight for a link on which the user particularly wants to reduce the traffic volume as the initial weight. In the case of the network in FIG. 3, for the links 1-19, initial weights in the first direction and the second direction are set as an initial first weight and an initial second weight, respectively.

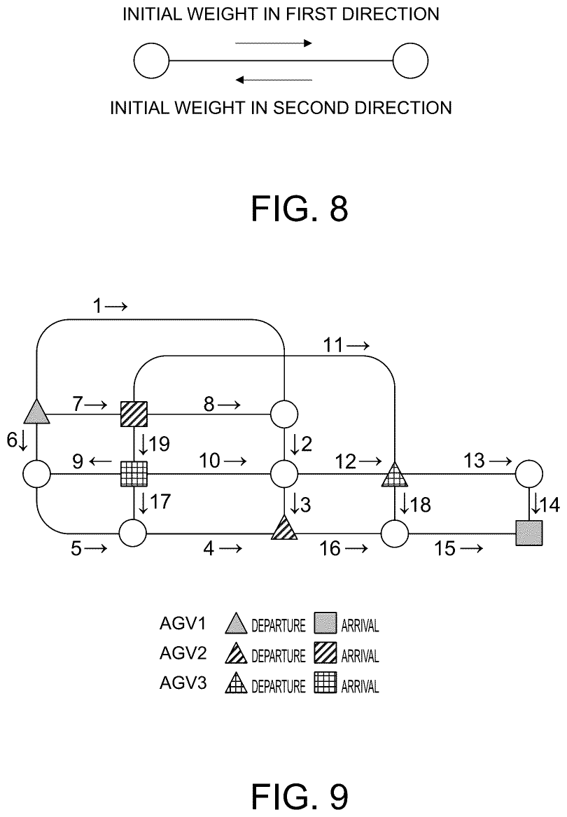

FIG. 8 shows an example of setting initial weights for a link in the first direction and the second direction. In the example in FIG. 8, the first direction corresponds to the right direction and the second direction corresponds to the left direction. However, the correspondence may be reversed. The initial weights in the first direction and the second direction may be the same value or different values. In this way, for all of the links 1-19, initial weights are set in the first direction and the second direction.

FIG. 9 is a diagram showing the first direction of each of the links 1-19. A thin solid arrow is attached to each link. It is assumed that the directions of the arrows are “the first direction” and the opposite directions of the arrows are “the second direction”. However, for each link, which direction is set to the first direction and which direction is set to the second direction can be defined freely.

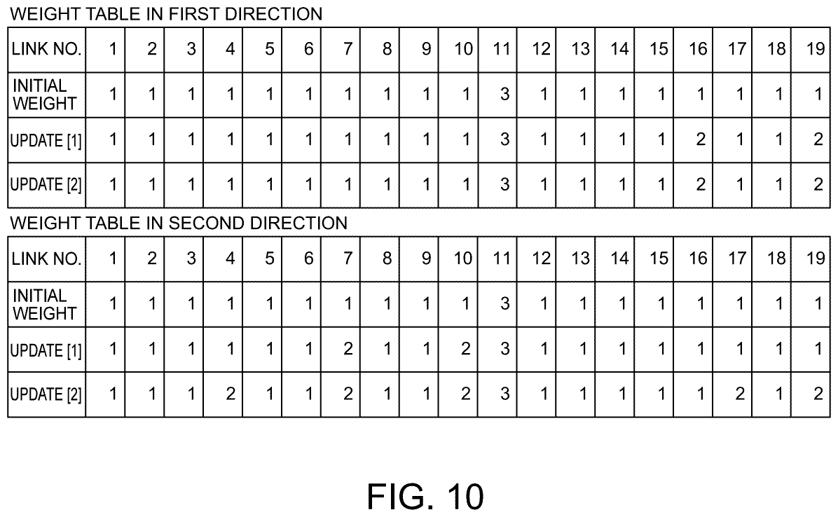

FIG. 10 shows an example of a weight table in the first direction and a weight table in the second direction according to this embodiment. A table that stores a weight for each link in each direction is shown, with the upper side being the weight table in the first direction and the lower side being the weight table in the second direction. In the first row of each table (the row of initial weights), an initial weight is set for each of the links 1-19 in each direction. In this example, the link 11 has an initial weight of 3 in both the first direction and the second direction, and the links 1-10 and 12-19 have an initial weight of 1 in both directions. Note that the values of the initial weights set for each link are not limited to the values shown in the figure.

The route generator 162 selects one AGV from a plurality of AGVs targeted for planning (S130). In this embodiment, it is assumed that the AGV 1, the AGV 2 and the AGV 3 are selected in this order, and the AGV 1 is selected here. For the selected AGV 1, a route is generated based on the initial weights (S140). The method of generating a route may be any method as long as it is based on the weights for the links. For example, a route may be determined by using the sum of the weights for the links (the route cost) as an index to minimize the index or lower it to a threshold value or less. At this time, the Dijkstra method may be used. Further, it is also possible to set a coefficient for each link (movement path) and use the sum of the multiplications of the coefficients and the weights or the sum of the coefficients and the squared weights as an index to determine a route so that the index is minimized or lowered to a threshold value or less. When the length of a movement path corresponding to a link is not reflected in the weight, the coefficient may be a value depending on the length of the movement path corresponding to the link. More generally, it is also possible to prepare a function including the weight as an input variable for each movement path and determine a route so that the index based on the sum of these functions is minimized or lowered to a threshold value or less.

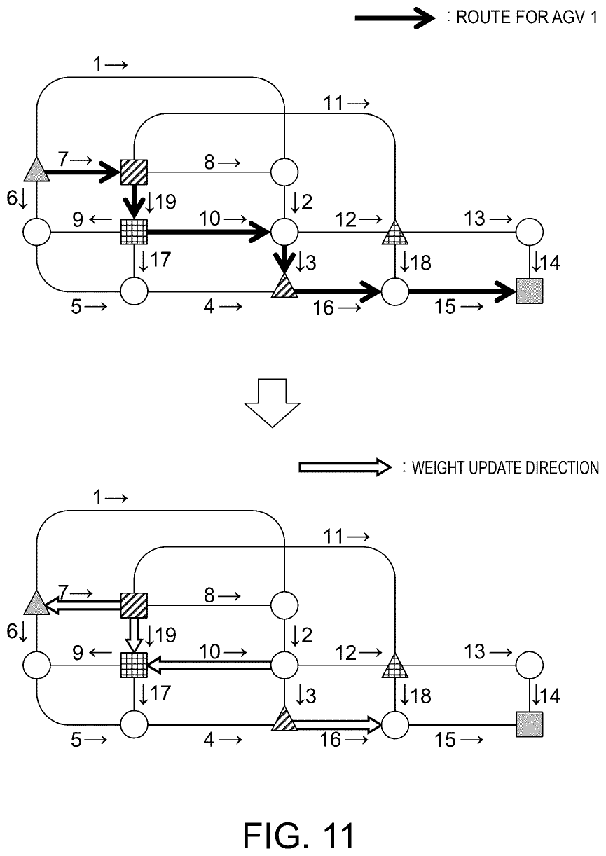

The upper figure in FIG. 11 shows an example of a route generated for the AGV 1. This route is a route in which the AGV 1 moves from its departure point (the node N1) to its arrival point (the node N12) along the links 7, 19, 10, 3, 16 and 15 in this order, and is indicated by thick arrows. Note that in this embodiment, a route for an AGV is indicated using link IDs, but it may be indicated using node IDs. In this case, the route for the AGV 1 is a route in which it moves (passes) through the nodes N1, N3, N4, N7, N8, N10 and N12 in this order.

When routes are generated for all AGVs (YES in S150), this process is ended. When there is an AGV for which a route has not yet been generated (NO in S150), the process proceeds to step S160. Here, since there is an AGV for which a route has not yet been generated, the process proceeds to step S160.

For each link included in the route for the AGV 1, the weight updater 163 checks whether the congestion adjustment parameter in one of the forward direction, the reverse direction, and both directions is set or not (S160). From the data example in FIG. 5, among the links 7, 19, 10, 3, 16 and 15 included in the route for the AGV 1, the congestion adjustment parameter in the forward direction is set for the links 16 and 19, and the congestion adjustment parameter in the reverse direction is set for the links 7 and 10. No congestion adjustment parameter is set for the other links.

For a link for which the congestion adjustment parameter in the forward direction is set, the route weight setter 161 updates the weight in the direction coincident with the movement direction of the AGV of the first direction and the second direction of the link (S170). The weight is updated, for example, by adding a predetermined value. However, it may be updated in other ways, such as by multiplying it by a certain constant. Further, the method of updating the weight may be common to all links, or may be defined for each link.

In this example, the congestion adjustment parameter in the forward direction is set for the links 16 and 19. Both the movement directions of the AGV 1 in the links 16 and 19 are the same direction (the first direction) as the arrows assigned to the links 16 and 19. For this reason, the weights corresponding to the first direction of the links 16 and 19 are updated.

For a link for which the congestion adjustment parameter in the reverse direction is set, the route weight setter 161 updates the weight in the direction coincident with the opposite direction of the movement direction of the AGV of the first direction and the second direction of the link (again S170). The weight is updated, for example, by adding a predetermined value. However, it may be updated in other ways, such as by multiplying it by a certain constant. Further, the method of updating the weight may be common to all links, or may be defined for each link.

In this example, the congestion adjustment parameter in the reverse direction is set for the links 7 and 10. The movement directions of the AGV 1 in the links 7 and 10 are the same direction (the first direction) as the arrows assigned to the links 7 and 10. For this reason, the weights corresponding to the second direction of the links 7 and 10 are updated.

The lower figure in FIG. 11 shows the directions in which the weights are updated for the links 7, 19, 10 and 16 using outlined arrows. Since the weights corresponding to the second direction are updated for the links 7 and 10, the outlined arrows (the weight update directions) are directed in the second direction. Since the weights corresponding to the first direction are updated for the links 19 and 16, the outlined arrows (the weight update directions) are directed in the first direction.

The row of update [1] in each of the table in the first direction and the weight table in the second direction in FIG. 10 above shows the weight for each link after the weights are updated for the links 7, 19, 10 and 16. In this example, the weights are updated by adding 1 to the weights before the update, but the value to be added is not limited to this. The value to be added may be different for each link.

The route generator 162 selects the AGV 2 as the next AGV. The route generator 162 generates a route for the AGV 2 based on the weights for the links after being updated in the processing for the AGV 1.

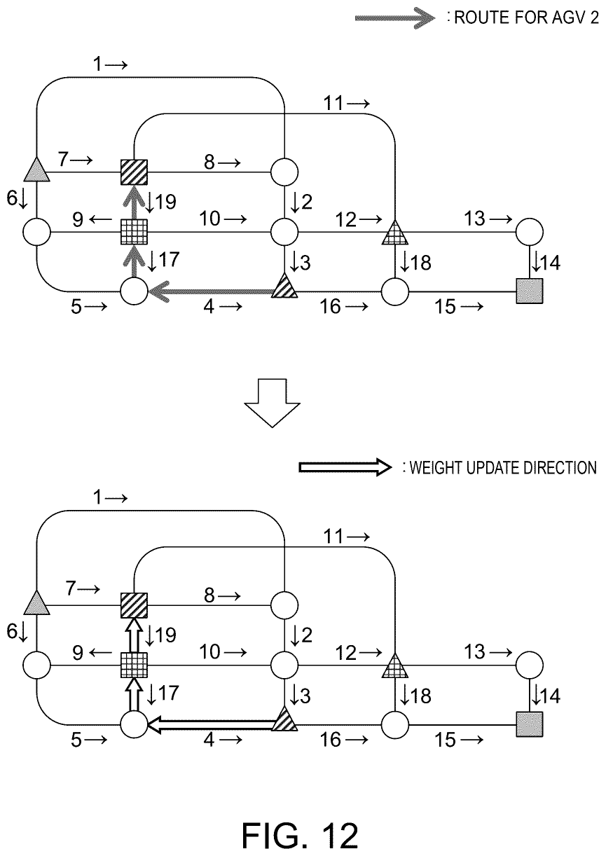

The upper figure in FIG. 12 shows an example of a route generated for the AGV 2. This route is a route in which the AGV 2 moves from its departure point (the node N8) to its arrival point (the node N3) along the links 4, 17 and 19 in this order, and is indicated by thick arrows. Note that although the route for the AGV 2 is indicated here using link IDs, it may be indicated using node IDs. In this case, the route for the AGV 2 is a route in which it moves (passes) through the nodes N8, N5, N4 and N3 in this order.

For each link included in the route for the AGV 2, the weight updater 163 checks whether the congestion adjustment parameter in one of the forward direction, the reverse direction, and both directions is set or not (S160). From the data example in FIG. 5, the congestion adjustment parameter in the forward direction is set for all of the links 4, 17 and 19 included in the route for the AGV 2.

The route weight setter 161 updates the weights in the direction coincident with the movement direction of the AGV 2 of the first direction and the second direction of the links 4, 17 and 19 for which the congestion adjustment parameter in the forward direction is set (S170).

In this example, all the movement directions of the AGV 2 in the links 4, 17 and 19 of the AGV 2 are the second direction of the links 4, 17 and 19. For this reason, the weights corresponding to the second direction of the links 4, 17 and 19 are updated.

The lower figure in FIG. 12 shows the directions in which the weights are updated for the links 4, 17 and 19 using outlined arrows. Since the weights corresponding to the second direction are updated for the links 4, 17 and 19, the outlined arrows (the weight update directions) are directed in the second direction.

FIG. 10 above shows an example in which the weights are updated for the links 4, 17 and 19. The row of update [2] in the weight table in the second direction shows the weight for each link after the weights are updated for the links 4, 17 and 19. In this example, the weights are updated by adding 1 to the weights before the update, but the value to be added is not limited to this. The value to be added may be different for each link.

The route generator 162 selects the AGV 3 as the next AGV. The route generator 162 generates a route for the AGV 3 based on the weights for the links after being updated in the processing for the AGV 2 (S140).

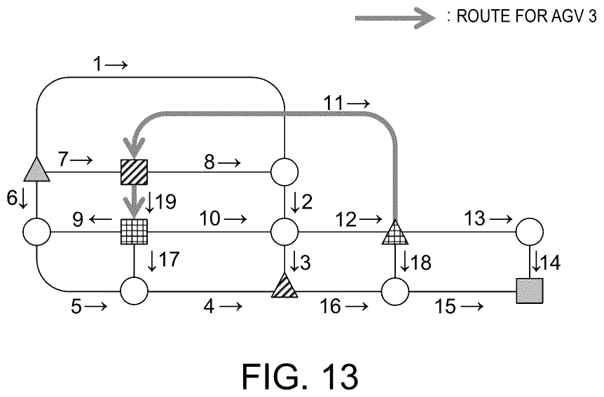

FIG. 13 shows an example of a route generated for the AGV 3. This route is a route in which the AGV 3 moves from its departure point (the node N9) to its arrival point (the node N4) along the links 11 and 19 in this order, and is indicated by thick arrows. Note that although the route for the AGV 3 is indicated here using link IDs, it may be indicated using node IDs. In this case, the route for the AGV 3 is a route in which it moves (passes) through the nodes N9, N3 and N4 in this order.

Now that routes have been generated for all AGVs targeted for planning (YES in S150), the processing in the route planner 160 is ended. Note that in this example, the weight update process for links (steps S160 and S170) is not performed for the last selected AGV 3, but it is also possible to perform the weight update process for the AGV 3. For example, the weight update process may also be performed for the AGV 3, and data indicating the finally obtained weight for each link may be presented to the user via an output interface such as a display device.

The movement plan generator 170 generates a movement plan for each AGV by planning the movement timing for each AGV based on the route for each AGV. Movement plans generated for AGVs 1, 2, and M correspond to a first movement plan, a second movement plan, and an M-th movement plan. At this time, the operation plan for each AGV in the operation plan storage 130 (e.g., at least one of the departure time and the arrival time of the AGV) or specification information for each AGV (e.g., speed information for each AGV) may be used.

The movement plan generator 170 generates a movement plan for each AGV so that AGVs do not content (e.g., collide) with each other by adjusting the timing of each AGV passing through a link or a node while making it a prerequisite to keep to (not to change) the route for each AGV. It may be a further prerequisite to keep to at least one of the departure time and the arrival time in the operation plan.

In the generation of a movement plan, when a movement path has a structure in which a plurality of AGVs cannot simultaneously move in the opposite directions (when AGVs collide with each other if simultaneously running in reverse on the same link), it is necessary to plan the movement timing of AGVs so that the AGVs do not simultaneously move in the opposite directions.

As one example of this method, a method is possible in which the time at which each AGV passes through a node or link included in its route is determined so that contention between AGVs is avoided.

As another method, it is determined that each AGV passes through the nodes in order of the nodes included in its route, and, for a node through which two or more AGVs pass in common (a common node), the priority (order) in which the two or more AGVs pass through the common node is determined. In the actual operation of AGVs, the commander 180 described later controls the order of passage in the common node in real time while communicating with the AGVs so that they keep to the above passage order at the common node while causing the AGVs to pass through the nodes in their respective determined orders of nodes. For example, when a high-priority AGV has not yet passed through the common node, a process such as making the other AGVs wait is performed to control them not to pass through the common node. The waiting location may be near the common node or a node passed just before the common node, or may be any position on a link on which no node is set.

The method of generating a movement plan itself does not matter in particular in this embodiment, for example, the method disclosed in Japanese Patent Laid-Open No. 2021-71891 or other methods can be used. The movement plan generator 170 stores the generated movement plan for each AGV in the movement plan storage 150.

The commander 180 reads out the movement plan for each AGV from the movement plan storage 150, and controls each AGV based on the movement plan. The commander 180 generates a control command for controlling the operation of a moving object 340 based on the movement plan for each AGV. The commander 170 transmits the generated control command to the moving object 340. Thereby, the operation of the moving object 340 is controlled. While communicating with each AGV, the commander 180 may control it to move/stop to control movement from the departure point to the arrival point. Alternatively, the overall data of the movement plan may be transmitted to each AGV, and each AGV may move autonomously based on the movement plan. At this time, the AGVs may communicate with each other to perform control for avoiding contention.

As described above, according to this embodiment, by updating the weights for each link using the congestion adjustment parameters, the number of AGVs moving in the same movement direction (the congestion degree) can be reduced for the links specified by the congestion adjustment parameter in the forward direction. For the links specified by the congestion adjustment parameter in the reverse direction, the number of AGVs moving in opposite directions (reverse directions) (the congestion degree) can be reduced. That is, the number of AGVs moving in the forward or reverse direction on links for which a congestion adjustment parameter is specified is reduced at the phase of generating routes. Thereby, in generating movement plans, it is possible to generate movement plans that reduce the possibility of a plurality of AGVs moving simultaneously in the forward or reverse direction on the same link. Since the number of AGVs moving in the forward or reverse direction on the same link can be reduced at the phase of generating routes, it is possible to eliminate or reduce the time or the number of times the AGVs are kept waiting even when controlling the order of passing through the above-described common nodes, thereby enabling efficient operation.

### Second Embodiment

Links for which weights are targeted for update in the weight update process (steps S160 and S170) in FIG. 7 in the first embodiment are limited to a partial target range in a route for an AGV (a target range of weight update). The target range is, for example, links (a route portion) within a certain range from the departure point, or links (a route portion) within a certain range back from the arrival point. The target range is a route portion of N links (movement paths) from the departure point or the arrival point of a moving object, where “N” is an integer equal to or greater than 1 and less than the number of the movement path links (the movement paths) included in the route for the moving object. Information indicating the target range is stored in the congestion adjustment parameter storage 110 or any other storage. The information indicating the target range may be input from the user. The target range may be specified for each link separately. Hereinafter, a case where the target range is three links from the departure point for the AGV 1 and one link back from the arrival point for the AGV 2 will be described as an example.

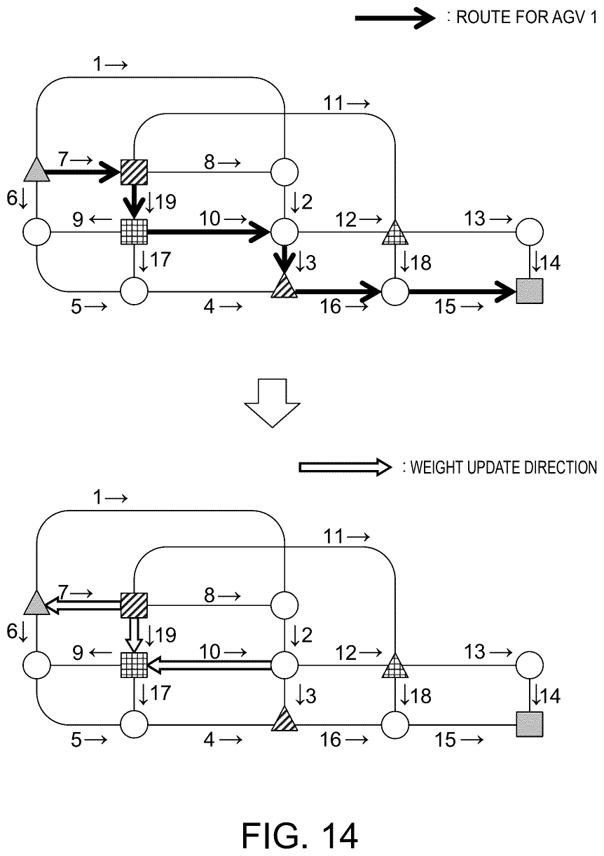

The upper figure in FIG. 14 shows an example of a route generated for the AGV 1. Since this figure is the same as the upper figure in FIG. 11, the description is omitted.

The lower figure in FIG. 14 shows the directions in which the weights are updated for the links 7, 19 and 10 using outlined arrows. In the first embodiment, the link 16 is also targeted for weight update, but in the second embodiment, the link 16 is not within 3 links from the departure point of the AGV 1, and therefore it is not targeted for update. The congestion adjustment parameter in the reverse direction is set for the links 7 and 10 as in the first embodiment, and the congestion adjustment parameter in the forward direction is set for the link 19 as in the first embodiment. Further, the links 7, 10 and 19 are within three links from the departure point of the AGV 2. Therefore, the links 7, 10 and 19 are targeted for weight update. Other respects are the same as in the first embodiment.

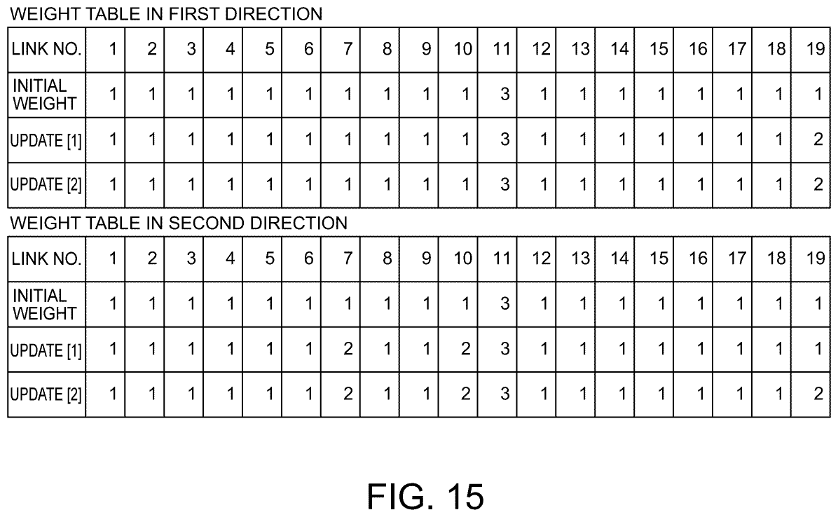

FIG. 15 shows an example of a weight table in the first direction and a weight table in the second direction according to this embodiment. The row of update [1] in the table in the first direction shows the weight for each link after the weight for the link 19 is updated. The row of update [1] in the weight table in the second direction shows the weight for each link after the weights for the links 7 and 10 are updated. Note that the values of the initial weights in each table are the same values as in FIG. 10 in the first embodiment. In this example, the weights are updated by adding 1 to the weights before the update, but the value to be added is not limited to this. The value to be added may be different for each link.

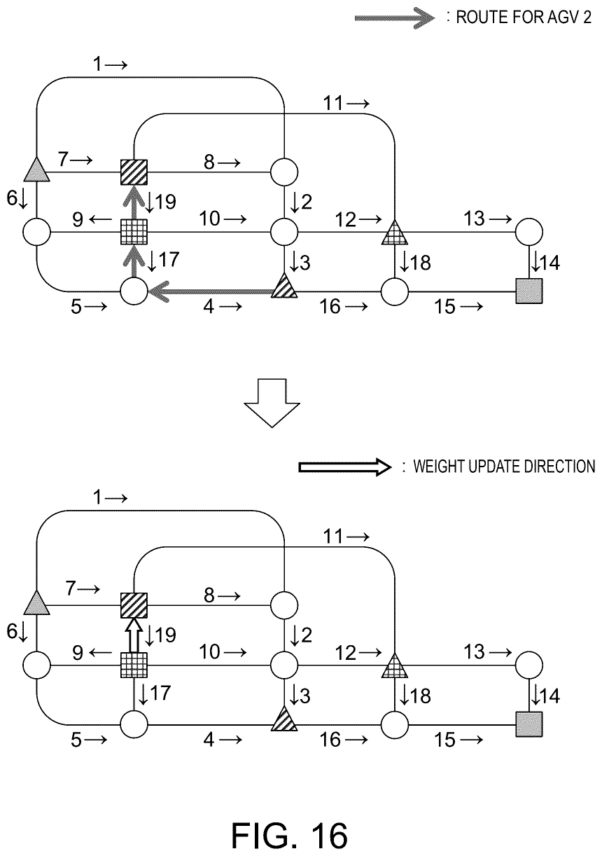

The upper figure in FIG. 16 shows an example of a route generated for the AGV 2 after the update of the weights for the links 7, 19 and 10 shown in FIG. 15. Since this figure is the same as the upper figure in FIG. 11, the description is omitted.

The lower figure in FIG. 16 shows the direction in which the weight is updated for the link 19 among the links 4, 17 and 19 included in the route for the AGV 2 using an outlined arrow. In the first embodiment, the links 17 and 4 are also targeted for weight update, but they exceed one link back from the arrival point, and therefore they are not targeted for update. Since the congestion adjustment parameter in the forward direction is set for the link 19 as in the first embodiment and it is within one link from the arrival point of the AGV 3, it is targeted for update.

The row of update [2] in the table in the first direction in FIG. 15 shows the weight for each link after the weight for the link 19 is updated. There is no update to the value for each link in the update [2] in the weight table in the second direction. In this example, the weights are updated by adding 1 to the weights before the update, but the value to be added is not limited to this. The value to be added may be different for each link.

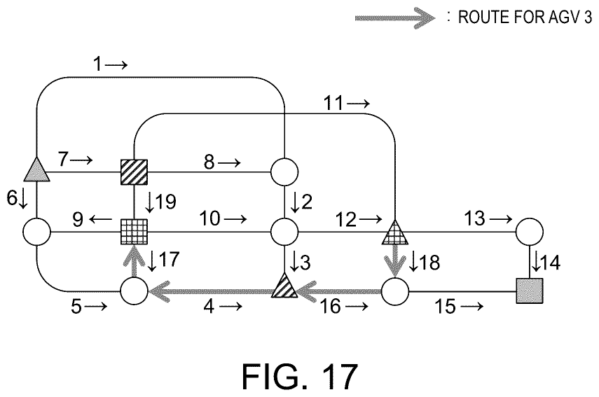

FIG. 17 shows an example of a route generated for the AGV 3 after the update of the weight of the link 19 for the AGV 2 shown in FIG. 16. A route different from that in FIG. 13 in the first embodiment is generated. This route is a route in which the AGV 3 moves from its departure point (the node N9) to its arrival point (the node N4) along the links 18, 16, 4 and 17 in this order. Since the weight for each link after the weight update for the AGV 2 is different from that in the first embodiment, a route different from that in the first embodiment is generated.

In this embodiment, only links within a certain number of links from the departure point or the arrival point are targeted for update, but the links targeted for update may be determined based on another criterion. For example, instead of the number of links from the departure point, links whose actual distance (e.g., the distance in two or three dimensions) is within a certain value may be targeted for update. Alternatively, by predicting the arrival time at each node through which the AGV passes from the speed of the AGV and the distance of the links, links predicted to be passed by a first time may be targeted for update. The first time may be a predetermined time or a time freely specified by the user. Passing through a link may include one or both of passing through the link completely and passing through the link not completely but being in the middle of passage. Thus, in this embodiment, links included in a range that satisfies a certain condition from the departure point or the arrival point can be targeted for weight update. As another method, it is possible to perform a process in which the farther the link is from the departure point or the arrival point, the smaller the weight to be added.

As described above, according to this embodiment, only links within the target range of weight update (e.g., a range that satisfies a certain condition from the departure point or the arrival point of an AGV) are targeted for weight update. This makes it possible to narrow down the range in which the congestion is alleviated and expand the possibilities of routes to be generated for the other AGVs.

As a modification, the second embodiment may be combined with the first embodiment. In the first embodiment, it may not be possible to generate a route for the AGV 2 due to the weight for at least one link of the links, although this depends on the algorithm of route generation. For example, when lowering the value of the above-described index to a threshold value or less is a condition for route generation, it may not be possible to generate a route with the index value equal to or less than the threshold value. In such a case, the weight update process for the AGV 1 is re-executed (redone), and at this time, only the links included in the target range of weight update in the second embodiment are targeted for weight update. This makes it possible to increase the possibility of being able to generate a route with the index value equal to or less than the threshold value for the AGV 2.

### Third Embodiment

In the second embodiment, only links included in the target range of weight update (e.g., a range that satisfies a certain condition from the departure point or the arrival point of AGV) are targeted for weight update. In this embodiment, in updating the weight for a link, the value of the updated weight for the link is set to a sufficiently larger value than normal possible values (e.g., the maximum value of possible values for the weight). Setting the value of the weight to a sufficiently large value means preventing the link from being used in the direction in which the weight is updated when generating a route for an AGV selected after the AGV (e.g., the next selected AGV). That is, it is synonymous with the absence (deletion) of the link in the direction. Thereby, the number of other AGVs moving in the same direction as or the reverse direction to the movement direction of the AGV on a link can be reduced more reliably within a short distance from the departure point or the like of the AGV. In the following description, the target range of weight update is within three links from the departure point of each AGV.

A data example in the congestion adjustment parameter storage according to this embodiment is assumed to be that in FIG. 5, which is the same as in the first embodiment. That is, the congestion adjustment parameter in the forward direction is set for the links 11, 18, 16, 4, 17 and 19, and the congestion adjustment parameter in the reverse direction is set for the links 7 and 10.

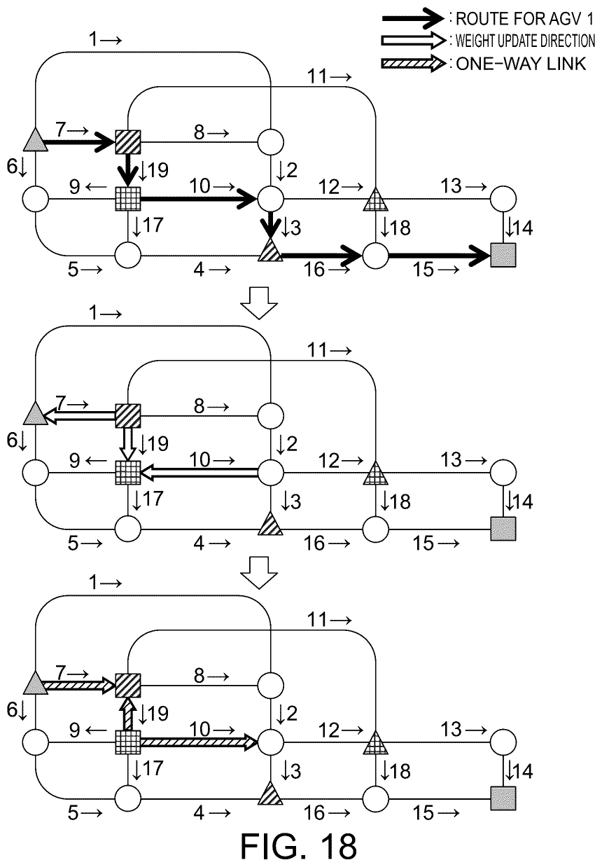

The upper figure in FIG. 18 shows an example of a route generated for the AGV 1. Since this figure is the same as the upper figure in FIG. 14 in the second embodiment, the description is omitted.

The central figure in FIG. 18 shows the directions in which the weights are updated for the links 7, 19 and 10 among the links 7, 19, 10, 3, 16 and 15 included in the route for the AGV 1 using outlined arrows. Since the link 16 exceeds three links from the departure point of the AGV 1, it is not targeted for weight update. Since the congestion adjustment parameter is not set for the links 3 and 15, they are not targeted for weight update. Since this figure is the same as the lower figure in FIG. 14 in the second embodiment, the description is omitted.

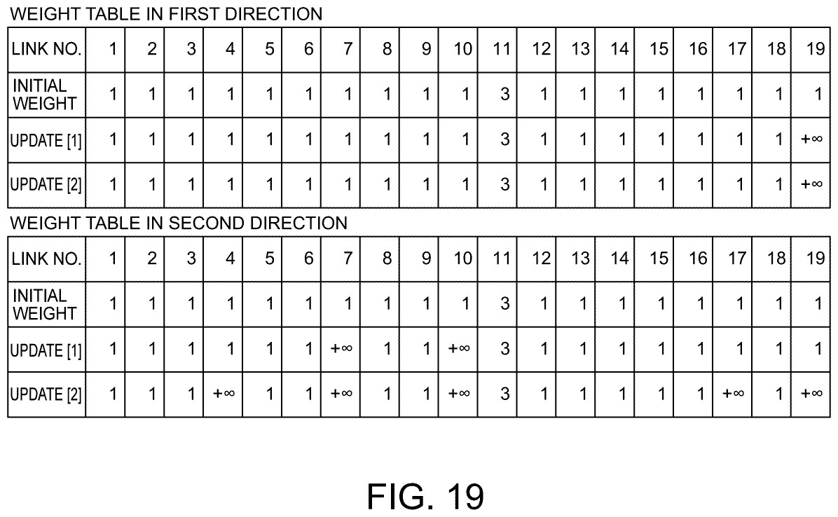

FIG. 19 shows an example of a weight table in the first direction and a weight table in the second direction according to this embodiment. The row of update [1] in the table in the first direction shows an example of the weight for each link after the weight for the link 19 is updated. The weight for the link 19 is the maximum value (denoted as “+∞” in the figure). Further, the row of update [1] in the table in the second direction shows an example of the weight for each link after the weights for the links 7 and 10 are updated. The weights for the links 7 and 10 are the maximum value (denoted as “+∞” in the figure). Note that the value for each link in the row of initial weights in each table is the same value as in FIG. 10 in the first embodiment.

The lower figure in FIG. 18 is a diagram showing that the links 19, 7 and 10 have become one-way links only in the opposite direction to the direction in which the weight is set to the maximum value. Arrow with diagonal lines represent one-way links. For example, since the weights in the second direction have become the maximum value on the links 7 and 10, they are one-way links that can be used by the other AGVs only in the first direction. Since the weight in the first direction has become the maximum value on the link 19, it is a one-way link that can be used by the other AGVs only in the second direction.

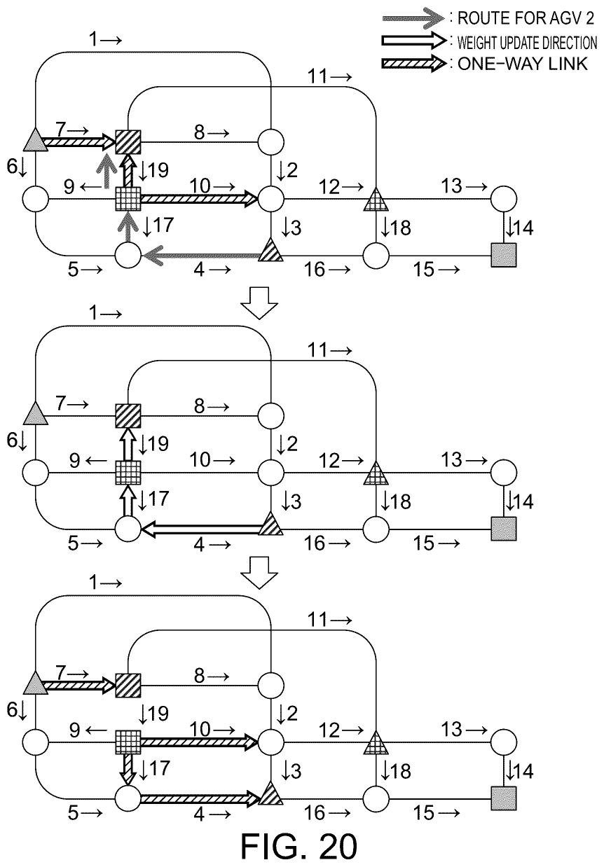

The upper figure in FIG. 20 shows an example of a route generated for the AGV 2 after the weights for the links 7, 19 and 10 are updated as in the update [1] in FIG. 19. This route includes the links 4, 17 and 19 in this order. This figure is the same as the upper figure in FIG. 11 except that the links 4, 17 and 19 are one-way links. Since the movement direction of the AGV 2 on the link 19 coincides with the direction of the one-way link of the link 19, the link 19 can be included in the route for the AGV 2.

The central figure in FIG. 20 shows the direction in which the weights are updated for the links 4, 17 and 19 included in the route for the AGV 2 using outlined arrows. Since the congestion adjustment parameter in the forward direction is set for all of the links 4, 17 and 19 and they are within three links from the departure point of the AGV 2, the links 4, 17 and 19 are targeted for weight update. That is, the weights in the second direction (the directions of the outlined arrows) on the links 4, 17 and 19 are targeted for update.

The row of update [2] in the table in the second direction in FIG. 19 shows an example of the weight for each link after the weights for the links 4, 17 and 19 are updated. The weights for the links 4, 17 and 19 are the maximum value. There is no update to the value for each link in the update [2] in the weight table in the first direction.

The lower figure in FIG. 20 is a diagram showing that the links 4 and 17 have become one-way links only in the opposite direction to the direction in which the weight has become the maximum value, and that the link 19 has been deleted (the weights have become the maximum value in both directions on the link 19). Arrow with diagonal lines represent one-way links. Since the link 19 has been deleted, there is no line between the nodes to which the link 19 was connected. Therefore, the link 19 cannot be used when routes for the other AGVs are generated. The links 4 and 17 can be used only in the first direction.

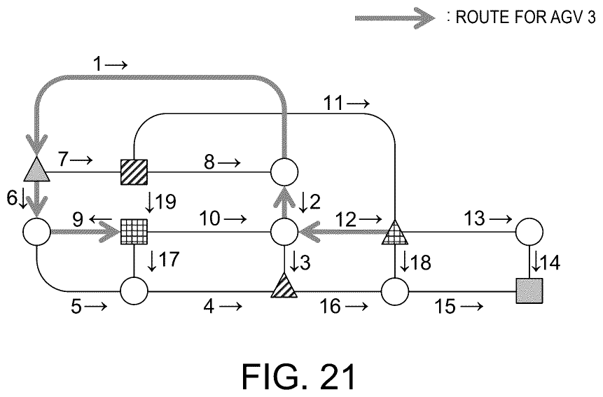

FIG. 21 shows an example of a route generated for the AGV 3 after the update of the weights of the links 4, 17 and 19 for the AGV 2 shown in FIG. 20. This route is a route in which the AGV 3 moves from its departure point (the node N9) to its arrival point (the node N4) along the links 12, 2, 1, 6 and 9 in this order. Since the link 19 cannot be used, a route that does not include the link 19 is generated.

As described above, according to this embodiment, by using a method of setting the weight in the first direction or the weight in the second direction to a maximum value as a method of updating the weight in the first direction or the second direction on a link, it is possible to prevent the other AGVs from moving on the link in the first direction or the second direction. This makes it possible to more reliably reduce the traffic volume (congestion) in the first direction or the second direction on the link.

### Fourth Embodiment

This embodiment is an embodiment in which a part or the whole of a route for at least one AGV of the AGVs 1-3 is determined in advance. Among the links included in the part or whole of the route determined in advance, the links specified by the congestion adjustment parameters are reflected in the initial weights in the initial weight setting process (see step S120 in FIG. 7).

The links included in the part or whole of the route determined in advance may be, for example, the links included within a certain number of links or a certain distance from the departure point or the arrival point in the route generated in the previous plan for the AGV. Alternatively, when a movement plan for the AGV is given in advance by the user or the like, they may be links scheduled to be passed by a predetermined time that are obtained by predicting the arrival time at each node from the speed of the AGV and the distance of the links. In this case, the movement plan for the AGV given in advance may be stored in the movement plan storage 150. Such an AGV may be excluded from the target of generating a route plan in the route planner 160 and the target of generating a movement plan in the movement plan generator 170.

In the following, a case where only a part of a route for the AGV 2 is predetermined will be described as an example. Specifically, it is assumed that the part including the links 16 and 18 starting from the departure point of the AGV 2 is determined in advance as a part of a route for the AGV 2.

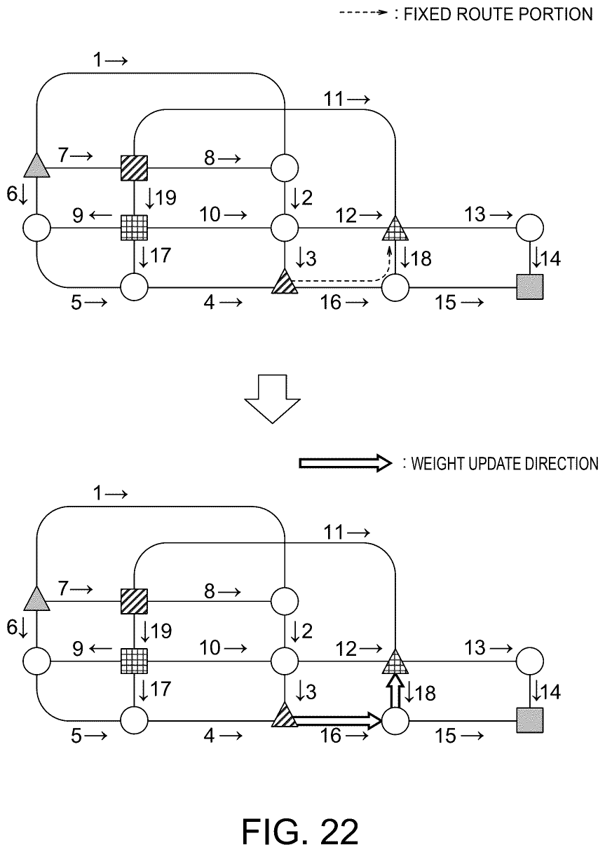

The upper figure in FIG. 22 shows an example in which the links 16 and 18 are fixed in advance as planned for the AGV 2. In this case, the AGV 2 corresponds to a third moving object for which a part or the whole of a route is determined in advance. Information indicating that the links 16 and 18 are used for the AGV 2 has been acquired in advance. It is assumed that nothing specific has been determined other than the use of the links 16 and 18 for the AGV 2, and links to be used other than the links 16 and 18 are determined by the route generator 162. A data example in the congestion adjustment parameter storage in this embodiment is the same as in FIG. 5. The congestion adjustment parameter in the forward direction is set for the links 16 and 18.

When setting initial weights for each link in the movement path network, the route weight setter 161 sets initial weights in the same manner as in the first to third embodiments, and additionally adds weights to the links 16 and 18 for the AGV 2 (update of the initial weights). The weights to be added is “1” in this example, but other values may be used.

The lower figure in FIG. 22 shows the directions in which the initial weights are updated for the links 16 and 18 using outlined arrows.

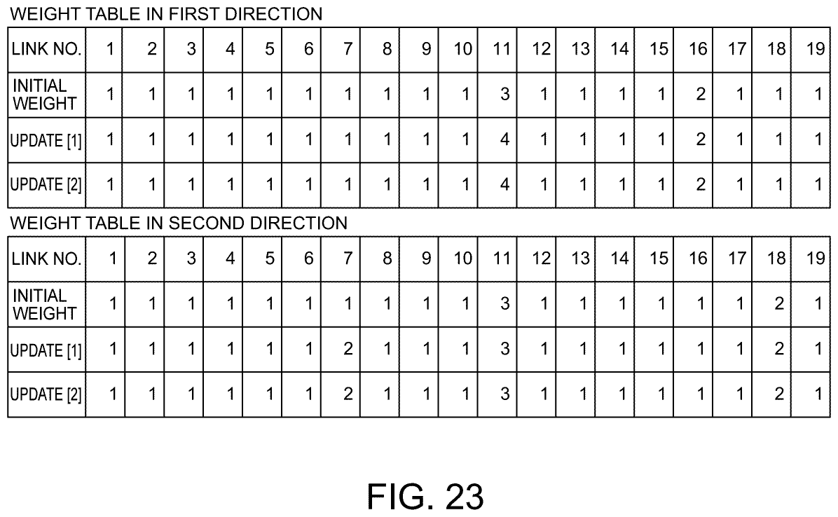

FIG. 23 shows an example of a weight table in the first direction and a weight table in the second direction according to this embodiment. In the rows of initial weights, initial weights are set for the links 1-19 in each direction. Basically, the initial weights are set in the same way as in the first embodiment, but in the weight table in the first direction, “1” is additionally added to the link 16, and the initial weight becomes “2”. Further, in the weight table in the second direction, “1” is additionally added to the link 18 and it becomes “2”.

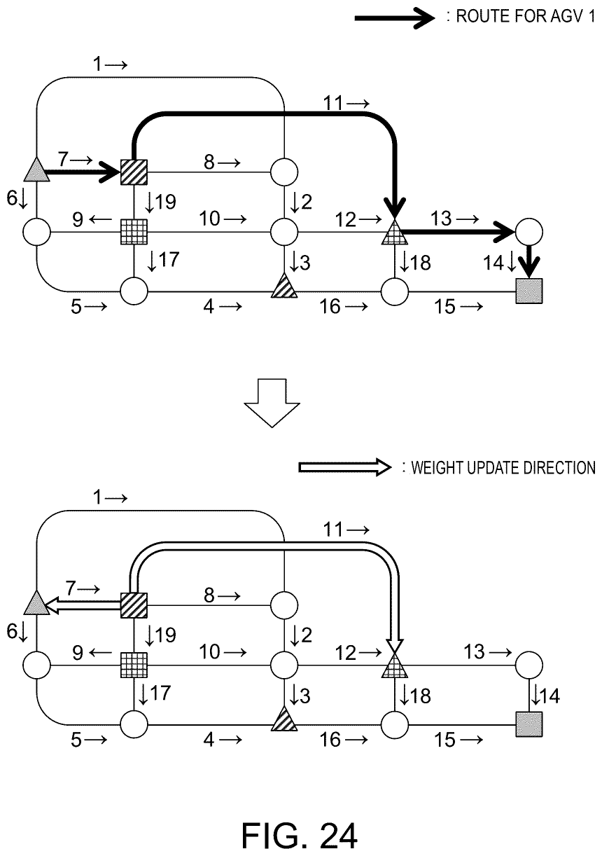

The upper figure in FIG. 24 is an example of a route generated for the AGV 1 based on the initial weights for each link in FIG. 23. This route is a route in which the AGV 1 moves from its departure point to its arrival point along the links 7, 11, 13 and 14 in this order, and is indicated by thick arrows.

The lower figure in FIG. 24 shows the directions in which the weights are updated for the links 7 and 11 among the links 7, 11, 13 and 14 included in the route for the AGV 1 using outlined arrows.

In the row of update [1] in the weight table in the first direction in FIG. 23 above, the weight for the link 11 is updated. In the row of update [1] in the weight table in the second direction, the weight for the link 7 is updated. In this example, the weight is updated by adding 1, but the value to be added is not limited to this.

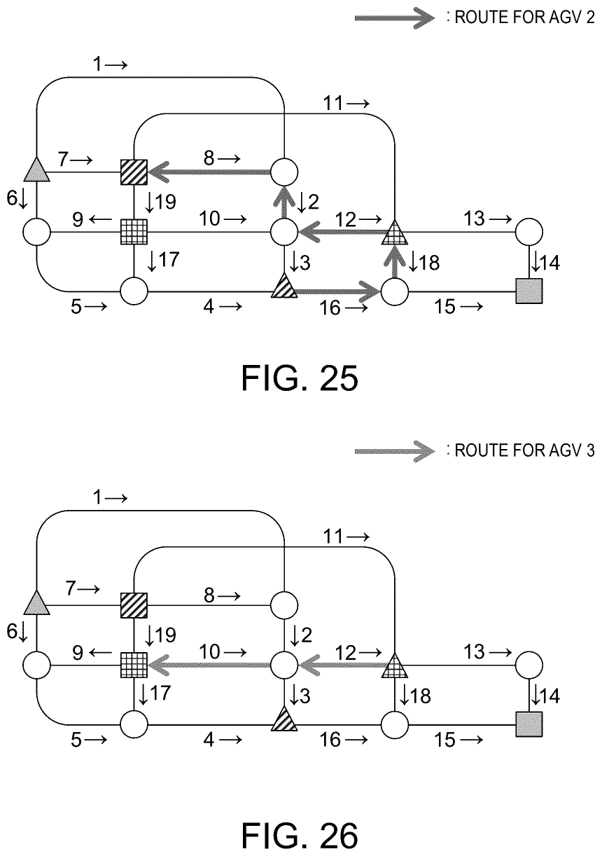

FIG. 25 shows an example of a route generated for the AGV 2 based on the weight for each link in the row of update [1] in each table in FIG. 23. This route is a route in which the AGV 2 moves from its departure point to its arrival point along the links 16, 18, 12, 2 and 8 in this order, and is indicated by thick arrows. The links 16 and 18 are links fixed for use in advance as described above. For the links 16 and 18, weights are reflected in advance as initial weights, so the weights are not updated again. Since the links 12, 2 and 8 are not links specified as the congestion adjustment parameter, the weights for these links are also not updated. Therefore, in the weight update process in step S170 for the AGV 2, the weight for any link is not updated. For this reason, the weight for each link in the row of update [2] in each table in FIG. 23 is the same value as the weight for each link in the row of update [1].

FIG. 26 shows an example of a route generated for the AGV 3 based on the weight for each link in the row of update [2] in each table in FIG. 23. This route is a route in which the AGV 3 moves from its departure point to its arrival point along the links 12 and 10 in this order, and is indicated by thick arrows.

As described above, according to this embodiment, it is possible to allow an AGV for which a part or the whole of a route is specified or scheduled in advance to preferentially use the links included in the specified route to prevent the other AGVs from using them.

### Fifth Embodiment

This embodiment is an embodiment in which there is a link for which the congestion adjustment parameter in both directions of the forward and reverse directions is set.

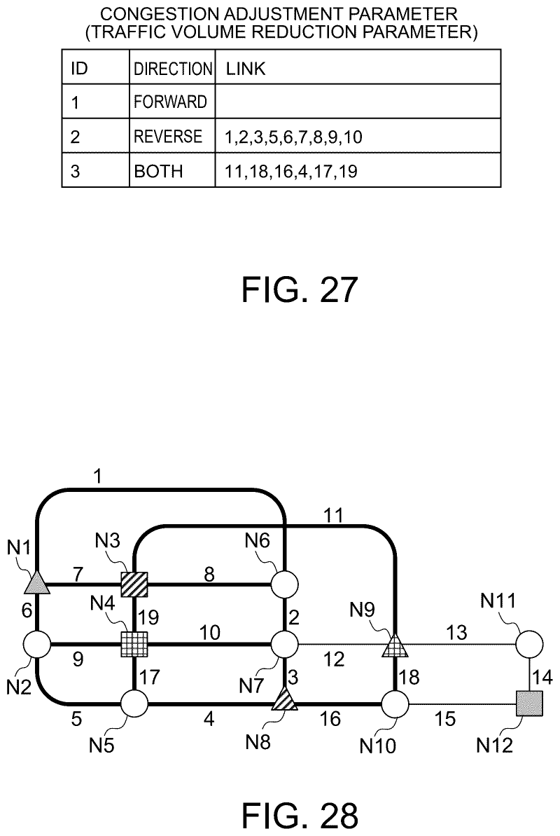

FIG. 27 shows a data example in the congestion adjustment parameter storage 110 according to this embodiment. The Congestion adjustment parameter in both directions instead of the forward direction is set for the links 11, 18, 16, 4, 17 and 19. The congestion adjustment parameter in the reverse direction is set for the links 1-3 and 5-10. Note that instead of setting the congestion adjustment parameter in both directions, it is also possible to set both the congestion adjustment parameter in the forward direction and the congestion adjustment parameter in the reverse direction for one link.

FIG. 28 shows links for which the congestion adjustment parameters in both directions and in the reverse direction shown in FIG. 27 are set in the movement path network. The links indicated by thick solid lines correspond to the links for which the congestion adjustment parameters in both directions and in the reverse direction are set.

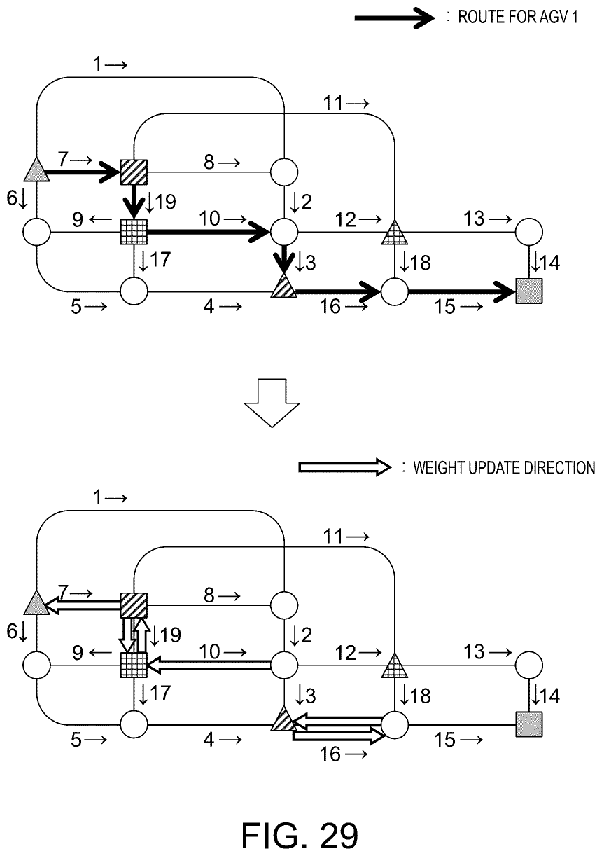

The upper figure in FIG. 29 shows an example of a route generated for the AGV 1. This figure is the same as the upper figure in FIG. 11.

The lower figure in FIG. 29 shows the directions in which the weights are updated for the links 7, 19, 10, 3 and 16 using outlined arrows. For the links 19 and 16, the weights in both directions are updated. For the links 7, 10 and 3, the weights in the reverse direction are updated.

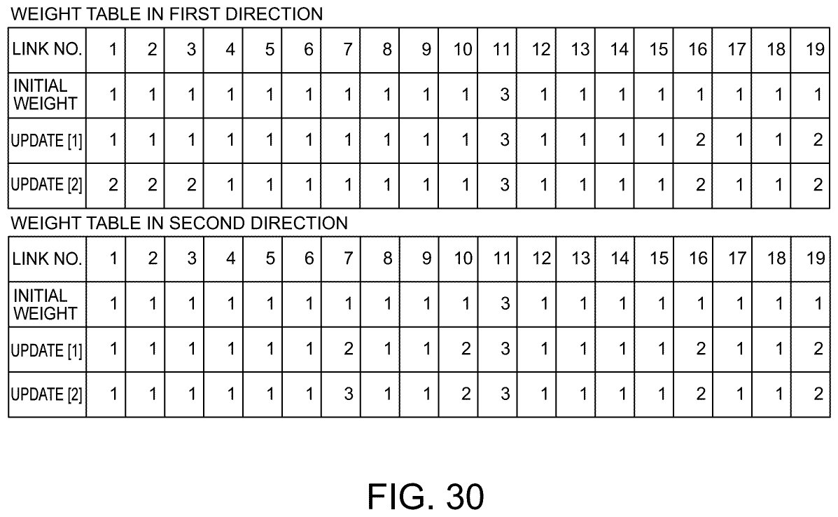

FIG. 30 shows an example of a weight table in the first direction and a weight table in the second direction according to this embodiment. The row of update [1] in the table in the first direction in FIG. 30 shows an example of the weight for each link after the weights for the links 16 and 19 are updated. The row of update [1] in the weight table in the second direction shows an example of the weight for each link after the weights for the links 7, 10, 16 and 19 are updated. Note that the value for each link in the row of initial weights in each table is the same value as in FIG. 10 in the first embodiment. In this example, the weights are updated by adding 1 to the weights before the update, but the value to be added is not limited to this. Further, the value to be added may be different for each link.

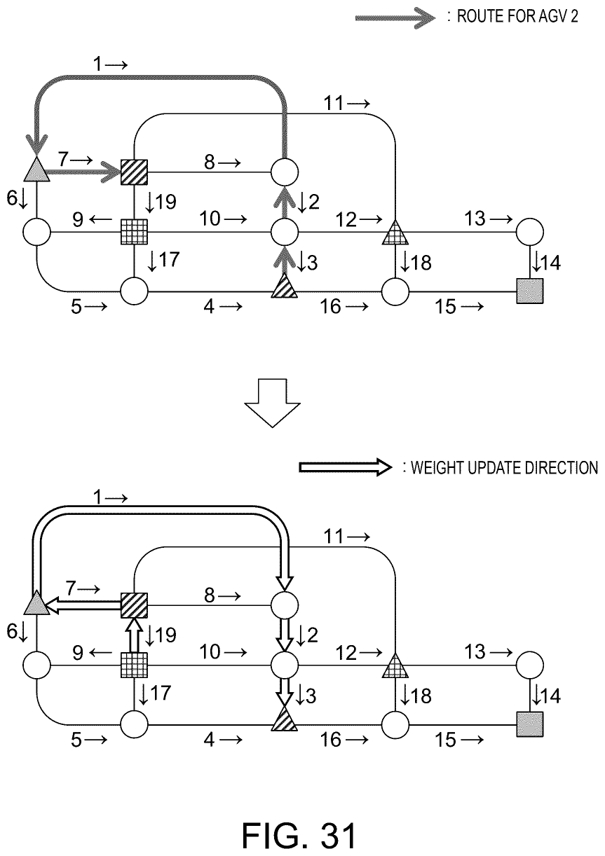

The upper figure in FIG. 31 shows an example of a route generated for the AGV 2 after the update of the weights for the links 7, 19, 10, 3 and 16 shown in FIG. 29.

The lower figure in FIG. 31 shows the direction in which the weights are updated for the links 3, 2, 1 and 7 included in the route for the AGV 2 using outlined arrows. For the link 7, the weight in the reverse direction is updated. For the links 1, 2 and 3, the weights in the forward direction are updated.

The row of update [2] in the table in the first direction in FIG. 30 above shows an example of the weight for each link after the weights for the links 1, 2 and 3 are updated. The row of update [2] in the table in the second direction shows an example of the weight for each link after the weight for the link 7 is updated. In this example, the weights are updated by adding 1 to the weights before the update, but the value to be added is not limited to this. The value to be added may be different for each link.

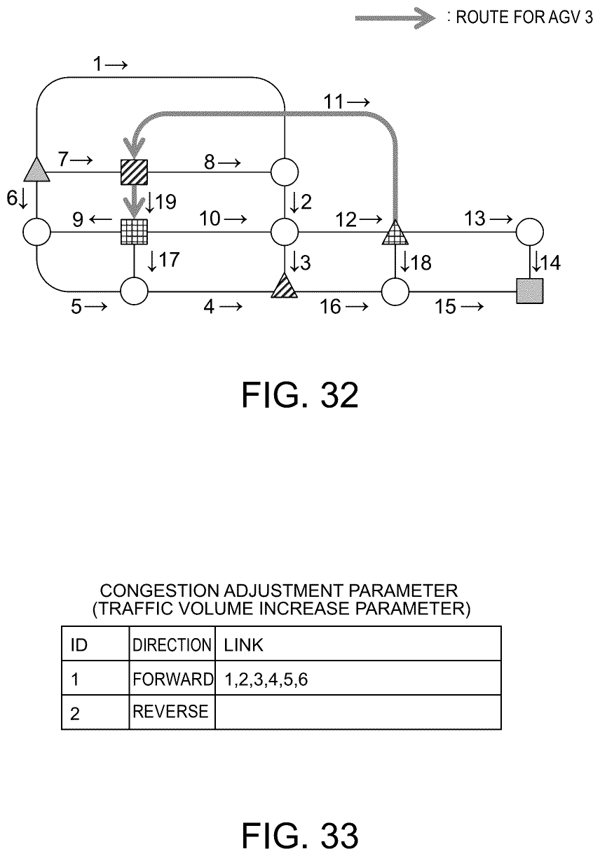

FIG. 32 shows an example of a route generated for the AGV 3 after the update of the weights of the links 7, 1, 2 and 3 for the AGV 2 shown in FIG. 31.

As described above, according to this embodiment, even when there are links for which the congestion adjustment parameter in both directions is set, it is possible to determine a route for each AGV while reducing the traffic volume in both directions on the links.

### Sixth Embodiment

In the first to fifth embodiments, a route for each AGV is generated so that traffic is reduced (congestion is alleviated) on links set by congestion adjustment parameters (specified links). In this embodiment, a route for each AGV is generated so that the traffic volume is increased on specified links set by congestion adjustment parameters. The congestion adjustment parameters in this embodiment are also referred to as traffic volume increase parameters. In the first to fifth embodiments, weights are increased (e.g., “1” is added) for the specified links among the links through which the AGVs move, but in this embodiment, weights are decreased (e.g., “1” is subtracted) for the specified links. This allows more AGVs to use the specified links.

FIG. 33 shows an example of congestion adjustment parameters according to this embodiment. The congestion adjustment parameter in the forward direction is set for the links 1-6. In this example, there is no link for which the congestion adjustment parameters in the reverse direction and the congestion adjustment parameters in both directions are set. This setting makes it possible to generate a route such that the forward directions of the links 1-6 are selected preferentially.

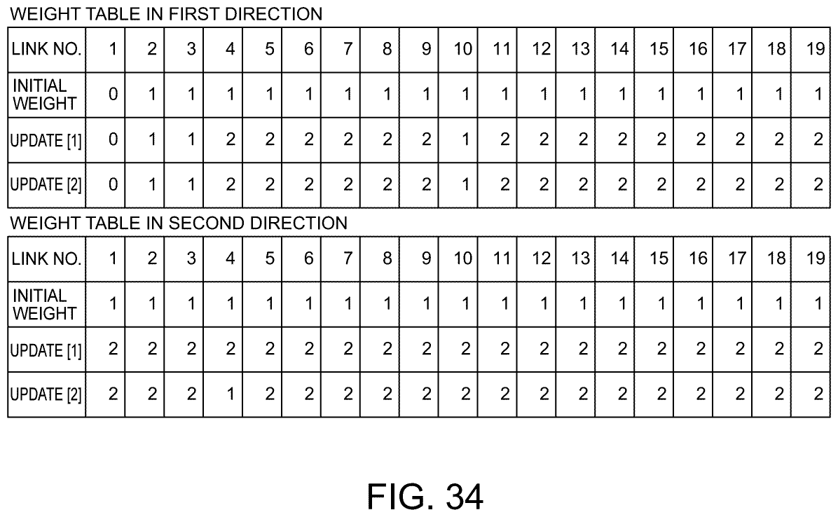

FIG. 34 shows an example of a weight table in the first direction and a weight table in the second direction according to this embodiment. For each of the links 1-19, an initial weight is set for each direction. Initial weights are set in the first row (the row of initial weights) in the weight table in the first direction and the weight table in the second direction. Basically, an initial weight of “1” is set for all links in both tables, but in the weight table in the first direction, “0” is set only for the link 1. This means to set a relatively small initial weight when it is desired to preferentially use the link 1 as much as possible. Note that the values of the initial weights set for each link are not limited to the values shown in the figure.

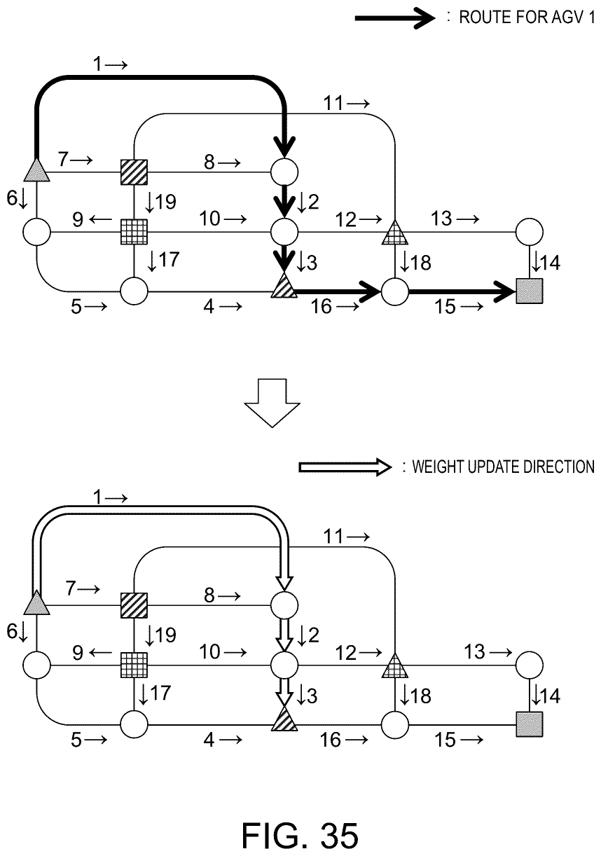

The upper figure in FIG. 35 is an example of a route generated for the AGV 1 based on the initial weights for each link shown in FIG. 34. This route is a route in which the AGV 1 moves from its departure point to its arrival point along the links 1, 2, 3, 16 and 15 in this order, and is indicated by thick arrows.

The lower figure in FIG. 35 shows the directions in which the weights are updated for the links 1, 2 and 3 using outlined arrows.

The row of update [1] in the weight table in the first direction in FIG. 34 above shows the weight for each link as a result of the update process. Each of the weights for the links 1-3 is decreased by 1 from the initial weight, and after the decrease, 1 is added to each of all the links 1-19. This can prevent the weight values from becoming negative values. If the route generation algorithm can handle negative weights, such a process of making the weight values positive may not be performed. Note that as a modification, instead of decreasing each of the weights for the links 1-3 by 1 from the initial weight, it is also possible to add “1” to each of the initial weights for the links other than the links 1-3. Along with the processing of the row of update [1] in the weight table in the first direction, the values obtained by adding “1” to each of the initial weights for the links 1-19 are stored in the row of update [1] in the weight table in the second direction as a result of the update process.

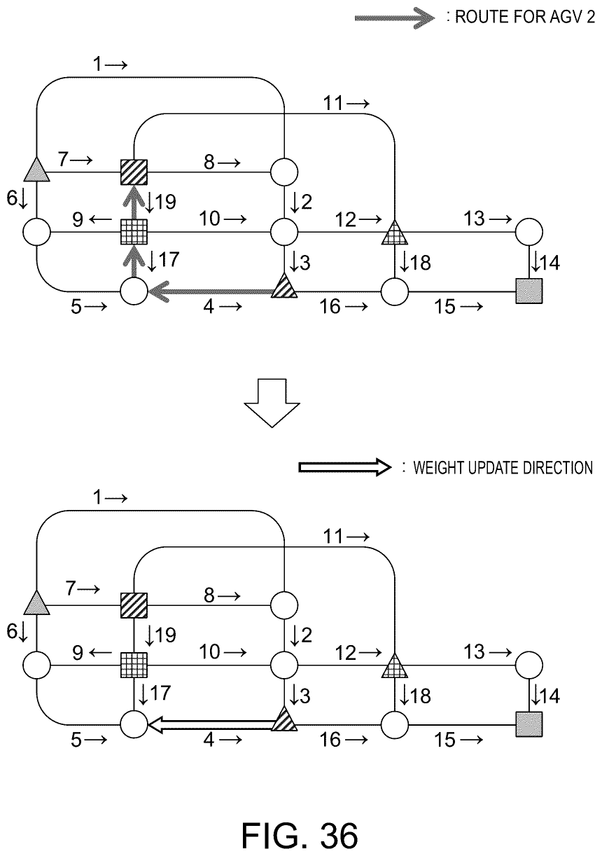

The upper figure in FIG. 36 shows an example of a route generated for the AGV 2 based on the weight for each link in the row of update [1] in each table in FIG. 34. This route is a route in which the AGV 2 moves from its departure point to its arrival point along the links 4, 17 and 19 in this order, and is indicated by thick arrows.

The lower figure in FIG. 36 shows the direction in which the weight is updated for the link 4, which is a specified link, among the links 4, 17 and 19 using an outlined arrow.

The row of update [2] in the weight table in the second direction in FIG. 34 above shows the weight for each link as a result of the update process. The weight for the link 4 is decreased by 1 from the weight in the update [1]. Note that in the weight table in the first direction, the values of the weights in the row of update [2] are the same as the weights in the row of update [1].

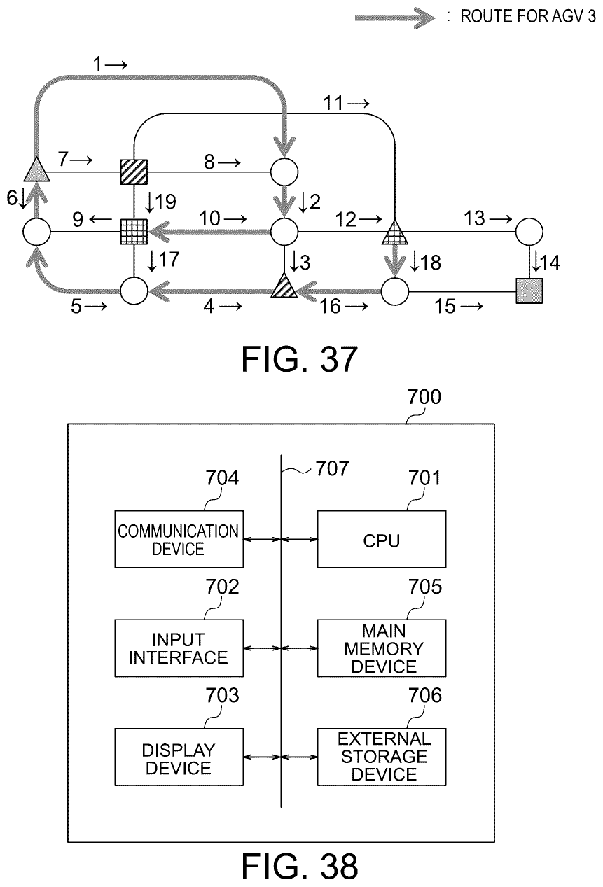

FIG. 37 shows an example of a route generated for the AGV 3 based on the weight for each link in the row of update [2] in each table in FIG. 36. This route is a route in which the AGV 3 moves from its departure point to its arrival point along the links 18, 16, 4, 5, 6, 1, 2 and 10 in this order, and is indicated by thick arrows.

As described above, according to this embodiment, weights for links are adjusted so that weights for specified links among the links through which the AGVs move are reduced using congestion adjustment parameters (traffic volume increase parameters). This makes it possible to generate a route for each AGV so that the specified links can be used by as many other AGVs as possible.

### (Hardware Configuration)

FIG. 38 illustrates a hardware configuration of an information processing apparatus 100 (route generation apparatus 100) according to any of the first to fifth embodiments. The information processing apparatus 100 is implemented by a computer device 700. The computer device 700 includes a CPU 701, an input interface 702, a display device 703, a communication device 704, a main memory device 705, and an external storage device 706, which are interconnected via a bus 707.

The CPU (Central Processing Unit) 701 executes an information processing program, which is a computer program or non-transitory computer readable medium, on the main memory device 705. The information processing program is a program that implements the functional configurations described above for the information processing apparatus 100. The information processing program may consist of a single program or a combination of multiple programs and scripts. By executing the information processing program, the CPU 701 realizes each of the functional configurations.

The input interface 702 is a circuit for inputting operation signals from input devices such as a keyboard, mouse, or touch panel into the information processing apparatus 100.

The display device 703 displays data output from the information processing apparatus 100. The display device 703 may be, for example, an LCD (liquid crystal display), an OLED (organic light-emitting diode display), a CRT (cathode-ray tube), or a PDP (plasma display panel), but is not limited thereto. Data output from the computer device 700 can be displayed on this display device 703.

The communication device 704 is a circuit that allows the information processing apparatus 100 to communicate wirelessly or via wired connection with external devices. Data can be input from an external device via the communication device 704. Data input from an external device can be stored in the main memory device 705 or the external storage device 706. The communication device 704 corresponds to the communication unit 190.

The main memory device 705 stores the information processing program, data necessary for executing the information processing program, and data generated by executing the information processing program. The information processing program is deployed and executed on the main memory device 705. The main memory device 705 may be, for example, RAM, DRAM, or SRAM, but is not limited thereto. Each storage unit or database of the information processing apparatus 100 may be implemented on the main memory device 705.

The external storage device 706 stores the information processing program, data necessary for executing the information processing program, and data generated by executing the information processing program. These programs and data are read out to the main memory device 705 at the time of program execution. The external storage device 706 may be, for example, a hard disk, optical disk, flash memory, or magnetic tape, but is not limited thereto. Each storage unit or database of the information processing apparatus 100 may be implemented on the external storage device 706.

The information processing program may be pre-installed in the computer device 700, may be stored on a storage medium such as a CD-ROM, or may be uploaded to the Internet.

The information processing apparatus 100 may be implemented by a single computer device 700 or may be configured as a system comprising a plurality of computer devices 700 interconnected with each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments of the present invention can also be configured as follows.

### Clauses

Clause 1. An information processing apparatus comprising a processing circuitry configured to:
generate a route for a first moving object including one or more of a plurality of movement paths, each of which allows movement in a first direction and a second direction opposite to the first direction, based on a first weight in the first direction and a second weight in the second direction associated with each movement path;
update at least one of the first weight and the second weight for the movement path included in the route for the first moving object, based on a movement direction of the first moving object on the movement path; and
generate a route for a second moving object including one or more of the movement paths, based on the updated at least one of the first weight and the second weight.

Clause 2. The information processing apparatus according to clause 1, wherein
only when the movement path included in the route for the first moving object is specified by a parameter specifying a movement path on which a number of other moving objects moving in a forward direction that is a movement direction of the first moving object or a reverse direction to the movement direction is specified to be reduced, the processing circuitry updates at least one of the first weight and the second weight for the movement path included in the route for the first moving object.

Clause 3. The information processing apparatus according to clause 2, wherein
when the parameter specifies the movement path on which the number of the other moving objects moving in the forward direction is to be reduced, the processing circuitry updates a weight in a same direction as the movement direction of the first moving object to a larger value, and
when the parameter specifies the movement path as a target for reducing the number of the other moving objects moving in the reverse direction, the processing circuitry updates a weight in a direction opposite to the movement direction of the first moving object to a larger value.

Clause 4. The information processing apparatus according to any one of clauses 1 to 3, wherein
only when the movement path included in the route for the first moving object is specified by a parameter specifying a movement path on which a number of other moving objects moving in a forward direction that is a movement direction of the first moving object or a reverse direction to the movement direction is specified to be increased, the processing circuitry updates at least one of the first weight and the second weight for the movement path included in the route for the first moving object.

Clause 5. The information processing apparatus according to clause 4, wherein
when the parameter specifies a movement path on which the number of other moving objects moving in the forward direction is to be increased, the processing circuitry updates a weight in a same direction as the movement direction of the first moving object to a smaller value; and
when the parameter specifies a movement path on which the number of other moving objects moving in the reverse direction is to be increased, the processing circuitry updates a weight in a direction opposite to the movement direction of the first moving object to a smaller value.

Clause 6. The information processing apparatus according to any one of clauses 2-5, wherein
the processing circuitry updates at least one of the first weight and the second weight only for one or more movement paths in a target range of weight update in the route for the first moving object, the a target range of weight update being identified by information identifying the one or more movement paths.

Clause 7. The information processing apparatus according to clause 6, wherein
the target range is N movement paths of the movement paths from a departure point of the first moving object, and “N” is an integer equal to or greater than 1 and less than a number of the one or more movement paths included in the route for the first moving object.

Clause 8. The information processing apparatus according to clause 6 or 7, wherein
the target range of weight update is one or more of the movement paths through which the first moving object is predicted to move from a departure point of the first moving object by a first time based on speed of the first moving object.

Clause 9. The information processing apparatus according to any one of clauses 6 to 8, wherein
the target range of weight update is N movement paths of the movement paths back from an arrival point of the first moving object, and “N” is an integer equal to or greater than 1 and less than a number of the one or more movement paths included in the route for the first moving object.

Clause 10. The information processing apparatus according to clause 2 or 3, wherein
the processing circuitry updates the first weight or the second weight to a maximum value of possible values for the first weight or the second weight.

Clause 11. The information processing apparatus according to clause 2 or 3, wherein
when it is not possible to generate the route for the second moving object due to a value of the first weight or the second weight for the movement path in the route for the first moving object, the processing circuitry updates at least one of the first weight and the second weight only for one or more movement paths in a target range of weight update in the route for the first moving object, the target range of weight update being identified by information identifying the one or more movement paths.

Clause 12. The information processing apparatus according to any one of clauses 1 to 11, wherein
a part or whole of a route for a third moving object including one or more of the movement paths is determined in advance, and
based on a movement direction of the third moving object on one of the one or more movement paths included in the part or whole of the route for the third moving object, the processing circuitry updates at least one of the first weight and the second weight for the movement path included in the part or whole of the route for the third moving object, and
the processing circuitry generates the route for the first moving object based on the updated at least one of the first weight and the second weight.

Clause 13. The information processing apparatus according to any one of clauses 1 to 12, wherein
the processing circuitry generates a first movement plan and a second movement plan representing timing at which the first moving object and the second moving object pass through the one or more movement paths included in the respective routes so that the first moving object and the second moving object do not contend with each other based on the route for the first moving object and the route for the second moving object.

Clause 14. The information processing apparatus according to clause 13, further comprising
a controlling circuitry configured to control the first moving object according to the first movement plan and control the second moving object according to the second movement plan.

Clause 15. The information processing apparatus according to any one of clauses 1 to 14, wherein
the first moving object and the second moving object are vehicles.

Clause 16. A method for generating a route for a moving object, comprising:
generating a route for a first moving object including one or more of a plurality of movement paths, each of which allows movement in a first direction and a second direction opposite to the first direction, based on a first weight in the first direction and a second weight in the second direction associated with the respective movement path;
updating at least one of the first weight and the second weight for a movement path included in the route for the first moving object, based on a movement direction of the first moving object on the movement path; and
generating a route for a second moving object including one or more of the movement paths, based on the updated at least one of the first weight and the second weight.

Clause 17. A non-transitory computer readable medium having a computer program stored therein which causes a computer to execute processes, comprising:
generating a route for a first moving object including one or more of a plurality of movement paths, each of which allows movement in a first direction and a second direction opposite to the first direction, based on a first weight in the first direction and a second weight in the second direction associated with the respective movement path;
updating at least one of the first weight and the second weight for a movement path included in the route for the first moving object, based on a movement direction of the first moving object on the movement path; and
generating a route for a second moving object including one or more of the movement paths, based on the updated at least one of the first weight and the second weight.

Clause 18. An information processing system comprising:
a first moving object and a second moving object, each configured to move in a movement environment including a plurality of movement paths, each of which allows movement in a first direction and a second direction opposite to the first direction; and
a processing circuitry configured to:
   generate a route for the first moving object including one or more of the movement paths, based on a first weight in the first direction and a second weight in the second direction associated with the respective movement path;
   update at least one of the first weight and the second weight for a movement path included in the route for the first moving object, based on a movement direction of the first moving object on the movement path; and
   generate a route for the second moving object including one or more of the movement paths, based on the updated at least one of the first weight and the second weight.

1. An information processing apparatus comprising a processing circuitry configured to:
generate a route for a first moving object including one or more of a plurality of movement paths, each of which allows movement in a first direction and a second direction opposite to the first direction, based on a first weight in the first direction and a second weight in the second direction associated with each movement path;
update at least one of the first weight and the second weight for the movement path included in the route for the first moving object, based on a movement direction of the first moving object on the movement path; and
generate a route for a second moving object including one or more of the movement paths, based on the updated at least one of the first weight and the second weight.

2. The information processing apparatus according to claim 1, wherein
only when the movement path included in the route for the first moving object is specified by a parameter specifying a movement path on which a number of other moving objects moving in a forward direction that is a movement direction of the first moving object or a reverse direction to the movement direction is specified to be reduced, the processing circuitry updates at least one of the first weight and the second weight for the movement path included in the route for the first moving object.

3. The information processing apparatus according to claim 2, wherein
when the parameter specifies the movement path on which the number of the other moving objects moving in the forward direction is to be reduced, the processing circuitry updates a weight in a same direction as the movement direction of the first moving object to a larger value, and
when the parameter specifies the movement path as a target for reducing the number of the other moving objects moving in the reverse direction, the processing circuitry updates a weight in a direction opposite to the movement direction of the first moving object to a larger value.

4. The information processing apparatus according to claim 1, wherein
only when the movement path included in the route for the first moving object is specified by a parameter specifying a movement path on which a number of other moving objects moving in a forward direction that is a movement direction of the first moving object or a reverse direction to the movement direction is specified to be increased, the processing circuitry updates at least one of the first weight and the second weight for the movement path included in the route for the first moving object.

5. The information processing apparatus according to claim 4, wherein
when the parameter specifies a movement path on which the number of other moving objects moving in the forward direction is to be increased, the processing circuitry updates a weight in a same direction as the movement direction of the first moving object to a smaller value; and
when the parameter specifies a movement path on which the number of other moving objects moving in the reverse direction is to be increased, the processing circuitry updates a weight in a direction opposite to the movement direction of the first moving object to a smaller value.

6. The information processing apparatus according to claim 2, wherein
the processing circuitry updates at least one of the first weight and the second weight only for one or more movement paths in a target range of weight update in the route for the first moving object, the a target range of weight update being identified by information identifying the one or more movement paths.

7. The information processing apparatus according to claim 6, wherein
the target range is N movement paths of the movement paths from a departure point of the first moving object, and “N” is an integer equal to or greater than 1 and less than a number of the one or more movement paths included in the route for the first moving object.

8. The information processing apparatus according to claim 6, wherein
the target range of weight update is one or more of the movement paths through which the first moving object is predicted to move from a departure point of the first moving object by a first time based on speed of the first moving object.

9. The information processing apparatus according to claim 6, wherein
the target range of weight update is N movement paths of the movement paths back from an arrival point of the first moving object, and “N” is an integer equal to or greater than 1 and less than a number of the one or more movement paths included in the route for the first moving object.

10. The information processing apparatus according to claim 2, wherein
the processing circuitry updates the first weight or the second weight to a maximum value of possible values for the first weight or the second weight.

11. The information processing apparatus according to claim 2, wherein
when it is not possible to generate the route for the second moving object due to a value of the first weight or the second weight for the movement path in the route for the first moving object, the processing circuitry updates at least one of the first weight and the second weight only for one or more movement paths in a target range of weight update in the route for the first moving object, the target range of weight update being identified by information identifying the one or more movement paths.

12. The information processing apparatus according to claim 1, wherein
a part or whole of a route for a third moving object including one or more of the movement paths is determined in advance, and
based on a movement direction of the third moving object on one of the one or more movement paths included in the part or whole of the route for the third moving object, the processing circuitry updates at least one of the first weight and the second weight for the movement path included in the part or whole of the route for the third moving object, and
the processing circuitry generates the route for the first moving object based on the updated at least one of the first weight and the second weight.

13. The information processing apparatus according to claim 1, wherein
the processing circuitry generates a first movement plan and a second movement plan representing timing at which the first moving object and the second moving object pass through the one or more movement paths included in the respective routes so that the first moving object and the second moving object do not contend with each other based on the route for the first moving object and the route for the second moving object.

14. The information processing apparatus according to claim 13, further comprising
a controlling circuitry configured to control the first moving object according to the first movement plan and control the second moving object according to the second movement plan.

15. The information processing apparatus according to claim 1, wherein
the first moving object and the second moving object are vehicles.

16. A method for generating a route for a moving object, comprising:
generating a route for a first moving object including one or more of a plurality of movement paths, each of which allows movement in a first direction and a second direction opposite to the first direction, based on a first weight in the first direction and a second weight in the second direction associated with the respective movement path;
updating at least one of the first weight and the second weight for a movement path included in the route for the first moving object, based on a movement direction of the first moving object on the movement path; and
generating a route for a second moving object including one or more of the movement paths, based on the updated at least one of the first weight and the second weight.

17. A non-transitory computer readable medium having a computer program stored therein which causes a computer to execute processes, comprising:
generating a route for a first moving object including one or more of a plurality of movement paths, each of which allows movement in a first direction and a second direction opposite to the first direction, based on a first weight in the first direction and a second weight in the second direction associated with the respective movement path;
updating at least one of the first weight and the second weight for a movement path included in the route for the first moving object, based on a movement direction of the first moving object on the movement path; and
generating a route for a second moving object including one or more of the movement paths, based on the updated at least one of the first weight and the second weight.

18. An information processing system comprising:
a first moving object and a second moving object, each configured to move in a movement environment including a plurality of movement paths, each of which allows movement in a first direction and a second direction opposite to the first direction; and
a processing circuitry configured to:
generate a route for the first moving object including one or more of the movement paths, based on a first weight in the first direction and a second weight in the second direction associated with the respective movement path;
update at least one of the first weight and the second weight for a movement path included in the route for the first moving object, based on a movement direction of the first moving object on the movement path; and
generate a route for the second moving object including one or more of the movement paths, based on the updated at least one of the first weight and the second weight.
